(19) United States
(12) Patent Application Publication
(10) Pub. No.: US 2015/0058082 A1
(43) Pub. Date: Feb. 26, 2015

(54) SERVER APPARATUS, SPECIFICATION DETERMINATION METHOD, AND SPECIFICATION DETERMINATION PROGRAM

(71) Applicant: NIKON CORPORATION, Tokyo (JP)

(72) Inventors: Kaori Suzuki, Kawasaki (JP); Kenichi Kawabe, Yokohama (JP); Fumitaka Akeda, Yokohama (JP); Kiyoshige Shibazaki, Tokyo (JP)

(73) Assignee: NIKON CORPORATION, Tokyo (JP)

(21) Appl. No.: 14/189,466

(22) Filed: Feb. 25, 2014

Related U.S. Application Data
(63) Continuation of application No. PCT/JP2012/072205, filed on Aug. 31, 2012.

(30) Foreign Application Priority Data
Aug. 31, 2011 (JP) 2011-189400

(51) Int. Cl. G06Q 30/02

(52) U.S. Cl. CPC G06Q 30/0203
USPC 705/7.32

(57) ABSTRACT

A server apparatus includes: a communication unit that communicates with a user terminal and a manufacturer terminal; an additional information communication unit that transmits, when the communication unit receives additional function information indicating a function to be added to a basic device from the user terminal, the additional function information to the manufacturer terminal through the communication unit; a specification information communication unit that transmits, when the communication unit receives specification information indicating a specification of an additional device for realizing the function from the manufacturer terminal, the specification information to the user terminal through the communication unit; and a specification determination unit that determines, when the communication unit receives, from the user terminal, selection information indicating one specification selected from among specifications indicated by the specification information transmitted to the user terminal, the one specification indicated by the selection information as the specification of the additional device.

### CROSS-REFERENCE TO RELATED APPLICATION

This is a Continuation Application of International Application No. PCT/JP2012/72205, filed on Aug. 31, 2012, which claims priority on Japanese Patent Application No. 2011-189400, filed on Aug. 31, 2011. The contents of the aforementioned applications are incorporated herein by reference.

### BACKGROUND

1. Field of the Invention

The present invention relates to a server apparatus, a specification determination method, and a specification determination program.

2. Background

In the related art, a technique that acquires a user's need or idea via the Internet and creates a product from the acquired need or idea has been proposed (for example, see Cuusoo Life, https://www.cuusoo.com/).

### SUMMARY

However, a technique that, in order to obtain a function to be added to a base terminal that is already present by association of an additional device and the base terminal, acquires a user's need or idea, determines a specification of an additional device for realizing the function to be added to the base terminal based on the need or idea and provides an additional device manufactured based on the specification has not been proposed. For this reason, it is difficult for the user to obtain an additional device that realizes a user-desired additional function in association with the base terminal.

An object of an aspect of the invention is to provide a server apparatus, a specification determination method and a specification determination program capable of determining a specification of an additional device that realizes a user-desired additional function in association with a base terminal.

According to an aspect of the invention, a server apparatus is provided, including: a communication unit that communicates with a user terminal and a manufacturer terminal; an additional information communication unit that transmits, when the communication unit receives additional function information indicating a function to be added to a basic device from the user terminal, the additional function information to the manufacturer terminal through the communication unit; a specification information communication unit that transmits, when the communication unit receives specification information indicating a specification of an additional device for realizing the function from the manufacturer terminal, the specification information to the user terminal through the communication unit; and a specification determination unit that determines, when the communication unit receives, from the user terminal, selection information indicating one specification selected from among specifications indicated by the specification information transmitted to the user terminal, the one specification indicated by the selection information as the specification of the additional device.

According to another aspect of the invention, a specification determination method is provided, including: transmitting, when additional function information indicating a function to be added to a basic device is received from a user terminal, the additional function information to a manufacturer terminal; transmitting, when specification information indicating a specification of an additional device for realizing the function is received from the manufacturer terminal, the specification information to the user terminal; and determining, when selection information indicating one specification selected from among specifications indicated by the specification information transmitted to the user terminal is received from the user terminal, the one specification indicated by the selection information as the specification of the additional device.

According to still another aspect of the invention, a specification determination program that causes a computer to execute a routine is provided including: an additional information communication step of transmitting, when a communication unit receives additional function information indicating a function to be added to a basic device from a user terminal, the additional function information to a manufacturer terminal through the communication unit; a specification information communication step of transmitting, when the communication unit receives specification information indicating a specification of an additional device for realizing the function from the manufacturer terminal, the specification information to the user terminal through the communication unit; and a specification determination step of determining, when the communication unit receives, from the user terminal, selection information indicating one specification selected from among specifications indicated by the specification information transmitted to the user terminal, the one specification indicated by the selection information as the specification of the additional device.

According to an aspect of the invention, it is possible to determine a specification of an additional device that realizes a user-desired additional function in association with a base terminal.

### BRIEF DESCRIPTION OF THE DRAWINGS

FIG. 1 is a diagram schematically illustrating a configuration of a product realization system according to an embodiment.

FIG. 2 is a block diagram schematically illustrating a configuration of a user terminal according to an embodiment.

FIG. 3 is a diagram illustrating an example of a browser screen of an idea input page displayed in a user terminal.

FIG. 4 is a diagram illustrating an example of a browser screen of a specification selection page displayed in a user terminal.

FIG. 5 is a diagram illustrating an example of a browser screen of a questionnaire answer page displayed in a user terminal.

FIG. 6 is a diagram illustrating an example of a browser screen of a polling page displayed in a user terminal.

FIG. 7 is a diagram illustrating an example of a browser screen of an additional device specification input page displayed in a user terminal.

FIG. 8 is a diagram illustrating an example of a browser screen of an improved idea input page displayed in a user terminal.

FIG. 9 is a block diagram schematically illustrating a configuration of a manufacturer terminal according to an embodiment.

FIG. 10 is a diagram illustrating an example of a browser screen of an idea list page displayed in a manufacturer terminal.

FIG. 11 is a diagram illustrating an example of a browser screen of a specification input page displayed in a manufacturer terminal.

FIG. 12 is a diagram illustrating an example of a browser screen of an additional device inspection item input page displayed in a manufacturer terminal.

FIG. 13 is a diagram illustrating an example of a browser screen of a patentable right transfer proposal page displayed in a manufacturer terminal.

FIG. 14 is a block diagram schematically illustrating a configuration of a server apparatus according to an embodiment.

FIG. 15 is a diagram illustrating an example of a table in which user registration information stored in a storage unit is written.

FIG. 16 is a diagram illustrating an example of a table in which manufacturer registration information stored in a storage unit is written.

FIG. 17 is a block diagram schematically illustrating a configuration of a control unit.

FIG. 18 is a diagram illustrating an example of a table in which idea information stored in a storage unit is written.

FIG. 19 is a diagram illustrating an example of a table in which specification information stored in a storage unit is written.

FIG. 20 is a diagram illustrating an example of a table in which additional device information stored in a storage unit is written.

FIG. 21A is a diagram illustrating an example of a table in which part information stored in a storage unit is written.

FIG. 21B is a diagram illustrating an example of a table in which inspection item information stored in a storage unit is written.

FIG. 22 is a block diagram schematically illustrating a configuration of a purchase information inspection unit.

FIG. 23 illustrates an example of a sequence diagram illustrating the flow of a user registration process.

FIG. 24 illustrates an example of a sequence diagram illustrating the flow of a manufacturer registration process.

FIG. 25 illustrates an example of a sequence diagram illustrating the flow of a manufacturing determination process.

FIG. 26 illustrates an example of a sequence diagram illustrating the flow of a purchase demand research process.

FIG. 27 illustrates an example of a sequence diagram illustrating the flow of a sale process of an additional device of which mass production is determined.

FIG. 28 illustrates an example of a sequence diagram illustrating the flow of an additional device authentication process.

FIG. 29 illustrates an example of a sequence diagram illustrating the flow of a process when novelty is present in an idea or specification.

FIG. 30 illustrates an example of a sequence diagram illustrating the flow of an improved idea employing process.

FIG. 31 is a diagram illustrating a display example of an original idea list displayed in a user terminal.

FIG. 32 is a diagram illustrating a display example of an improved idea list displayed in a user terminal.

FIG. 33 is a diagram illustrating an example of a browser screen of a registration content current status confirmation page displayed in a user terminal.

FIG. 34 is a diagram illustrating an image of a process in which an improved idea is derived from an original idea and finally leads to commercialization of product.

### DESCRIPTION OF THE EMBODIMENTS

Hereinafter, embodiments of the invention will be described in detail with reference to the accompanying drawings. In the present embodiments, as an example of a product realization system that determines a specification of an additional device that cooperates with a predetermined base terminal to realize a desired function, an example of a product realization system that determines a specification of an additional device that is physically connected to a predetermined base terminal to realize a desired function will be described.

In the present embodiments, a case where the additional device is physically connected to the base terminal to realize the desired function is described as an example, but the invention is not limited thereto, and the additional device may not be physically connected to the base terminal. For example, the product realization system may determine the specification of the additional device that cooperates with the base terminal using wireless communication, infrared communication or the like to realize the desired function.

<Outline of Product Realization System>

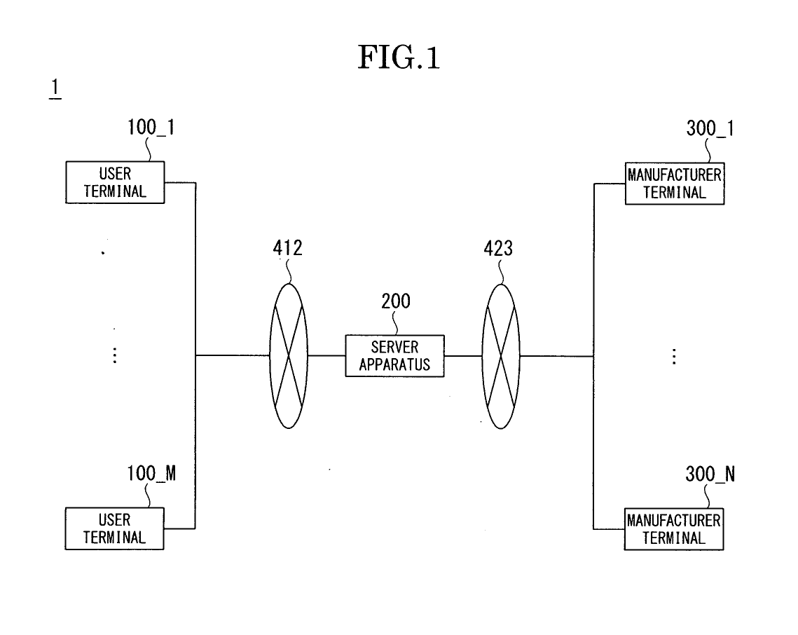

FIG. 1 is a diagram schematically illustrating a configuration of a product realization system 1 according to an embodiment of the invention. The product realization system 1 includes M (M is an integer of 1 or greater) user terminals 100_{—}i (i is an integer from 1 to M) of user terminals 100_1, . . . , 100_M; a server apparatus 200; and N (N is an integer of 1 or greater) manufacturer terminals 300_{—}j (j is an integer from 1 to N) of manufacturer terminals 300_1, . . . , 300_N. Each user terminal 100_{—}i is connected to the server apparatus 200 through a communication network 412. Further, each manufacturer terminal 300_{—}j is connected to the server apparatus 200 through a communication network 423.

Each user terminal 100_{—}i is able to communicate with the server apparatus 200 through the communication network 412. Each user terminal 100_{—}i transmits a variety of information to the server apparatus 200 through the communication network 412. Further, each user terminal 100_{—}i receives a variety of information transmitted from the server apparatus 200 through the communication network 412.

Similarly, each manufacturer terminal 300_{—}j is able to communicate with the server apparatus 200 through the communication network 423. Each manufacturer terminal 300_{—}j transmits a variety of information to the server apparatus 200 through the communication network 423. Further, each manufacturer terminal 300_{—}j receives a variety of information transmitted from the server apparatus 200 through the communication network 423.

The server apparatus 200 receives a variety of information transmitted from each user terminal 100_{—}i or each manufacturer terminal 300_{—}j. Further, the server apparatus 200 transmits a variety of information to each user terminal 100_{—}i or each manufacturer terminal 300_{—}j.

The server apparatus 200 performs information communication with one or more user terminals 100_{—}i and one or more manufacturer terminals 300_{—}j, to thereby determine a specification of an additional device that adds a specific function to a basic device.

<Schematic Configuration of User Terminal>

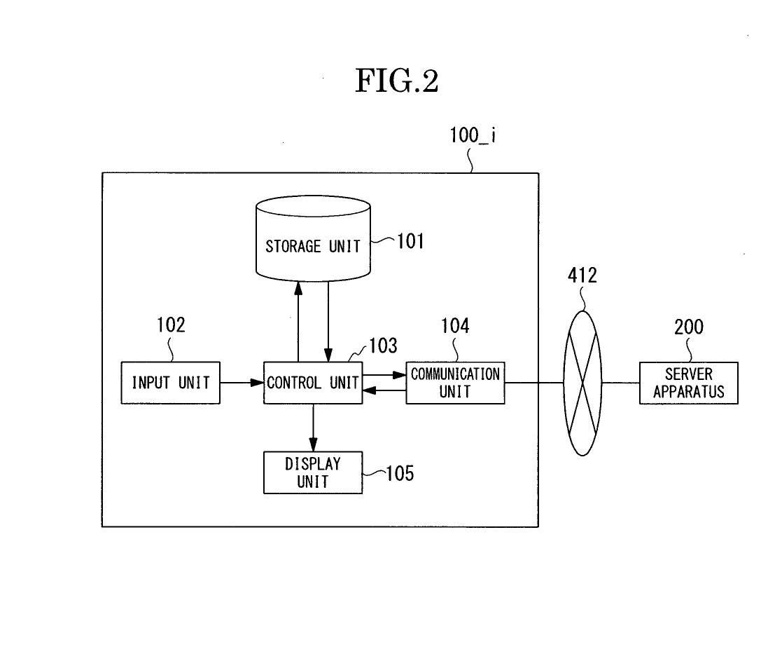

FIG. 2 is a block diagram schematically illustrating a configuration of the user terminal 100_{—}i in the present embodiment. The user terminal 100_{—}i includes a storage unit 101, an input unit 102, a control unit 103, a communication unit 104, and a display unit 105.

In the storage unit 101, a program of an Internet browser executed by the control unit 103 is stored.

The input unit 102 receives input information input by a user who operates the user terminal 100_{—}i. The input unit 102 outputs the received input information to the control unit 103. The input unit 102 is a keyboard and a mouse, for example. Specifically, for example, the input unit 102 outputs key input information (for example, idea input information) input through the keyboard to the control unit 103. Further, for example, the input unit 102 outputs movement instruction information for instructing movement of a cursor and left-click information indicating that a mouse is left-clicked to the control unit 103.

The control unit 103 reads the program of the Internet browser from the storage unit 101, and executes the read program of the Internet browser. Thus, the control unit 103 allows the display unit 105 to display a display screen of the Internet browser.

The control unit 103 changes the display in the display unit 105 based on the input information input through the input unit 102. Specifically, for example, the control unit 103 moves the position of the cursor displayed in the display unit 105 based on the cursor movement instruction information input through the input unit 102.

Further, the control unit 103 temporarily holds the key input information input through the input unit 102. Further, when the cursor is present on a predetermined button (for example, a radio button, a select button or the like) in the display screen of the display unit 105, the control unit 103 temporarily holds selection information selected by the left-click information based on the left-click information input through the input unit 102. Further, the control unit 103 changes the display screen of the display unit 105 based on the left-click information input through the input unit 102.

Further, when the cursor is present on a predetermined button (for example, a select button, a transmit button or the like) in the display screen of the display unit 105, if the left-click information is input through the input unit 102, the control unit 103 transmits the key input information or the selection information that is temporarily held to the server apparatus 200 through the communication unit 104.

Further, the control unit 103 allows the display unit 105 to display a page of the server apparatus 200 based on the information input through the communication unit 104.

The communication unit 104 transmits the key input information or the selection information input from the control unit 103 to the server apparatus 200 under the control of the control unit 103.

On the other hand, the communication unit 104 receives information transmitted from the server apparatus 200, and outputs the received information to the control unit 103.

<Web Page Displayed in User Terminal>

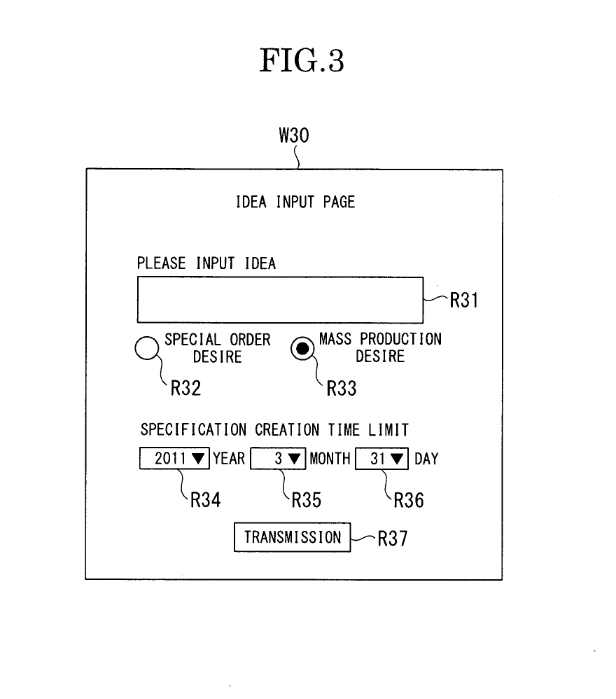

Next, examples of a Web page displayed in the display unit 105 will be described with reference to FIGS. 3 to 8. FIG. 3 is a diagram illustrating an example of a browser screen W30 of an idea input page displayed in the user terminal 100_{—}i. In the browser screen W30 shown in the figure, an input section R31, a radio button R32, a radio button R33, a select box R34, a select box R35, a select box R36 and a transmission button R37 are shown.

The input section R31 is an input section in which an idea is to be input. The radio button R32 is a button for selecting a special order desire, and the radio button R33 is a button for selecting a mass production desire. Thus, the user can alternatively select the special order desire or the mass production desire.

Further, the select box R34 is a pull-down type menu for selecting the year of a specification creation time limit that is a time limit for when a specification of an idea is to be created. Similarly, the select box R35 is a pull-down type menu for selecting the month of the specification creation time limit. Similarly, the select box R36 is a pull-down type menu for selecting the date of the specification creation time limit. Thus, the user can select the specification creation time limit.

The transmission button R37 is a button for transmitting a variety of information input in the browser screen W30 to the server apparatus 200. When the cursor is present on the transmission button R37 in the display screen of the display unit 105, if the mouse is left-clicked and the left-click information is input through the input unit 102, the control unit 103 transmits idea information indicating the idea input in the input section R31, information (need information) about the presence or absence of the mass production desire selected by the radio button (R32 or R33) and information about the specification creation time limit selected by the select box (R34, R35 or R36) to the server apparatus 200 through the communication unit 104.

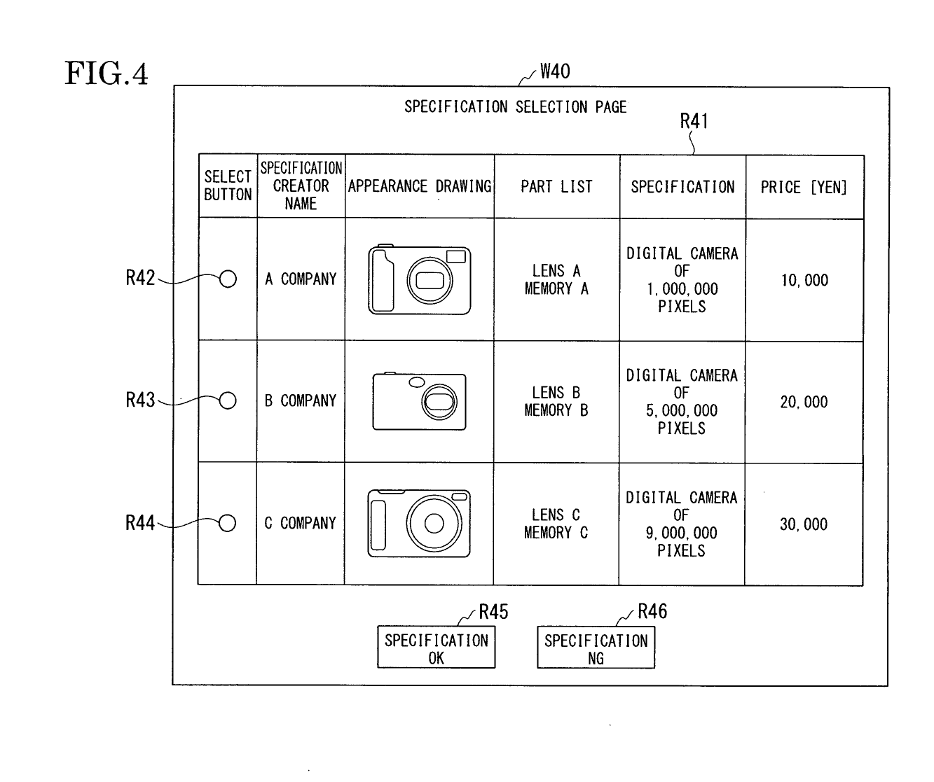

FIG. 4 is a diagram illustrating an example of a browser screen W40 of a specification selection page displayed in the user terminal 100_{—}i. In the browser screen W40 shown in the figure, Table R41 in which each set of a specification creator name, an appearance drawing, a part list, a specification and a cost is written is shown. Further, in Table R41, a radio button R42, a radio button R43 and a radio button R44 are shown. Thus, the user can select one among the three radio buttons (R42 to R44), to thereby select one from among three specifications.

Further, in the browser screen W40 shown in the figure, a specification OK button R45 and a specification NG button R46 are shown. In a state where one of three radio buttons is selected, when the cursor is present on the specification OK button R45 in the display screen of the display unit 105, if the mouse is left-clicked and the left-click information is input through the input unit 102, the control unit 103 transmits a specification ID associated with the selected radio button to the server apparatus 200 through the communication unit 104. Here, the specification ID is identification information for identifying the specification.

Further, when the cursor is present on the specification NG button R46 in the display screen of the display unit 105, if the mouse is left-clicked and the left-click information is input through the input unit 102, the control unit 103 transmits specification NG information indicating that all displayed specifications are rejected to the server apparatus 200 through the communication unit 104.

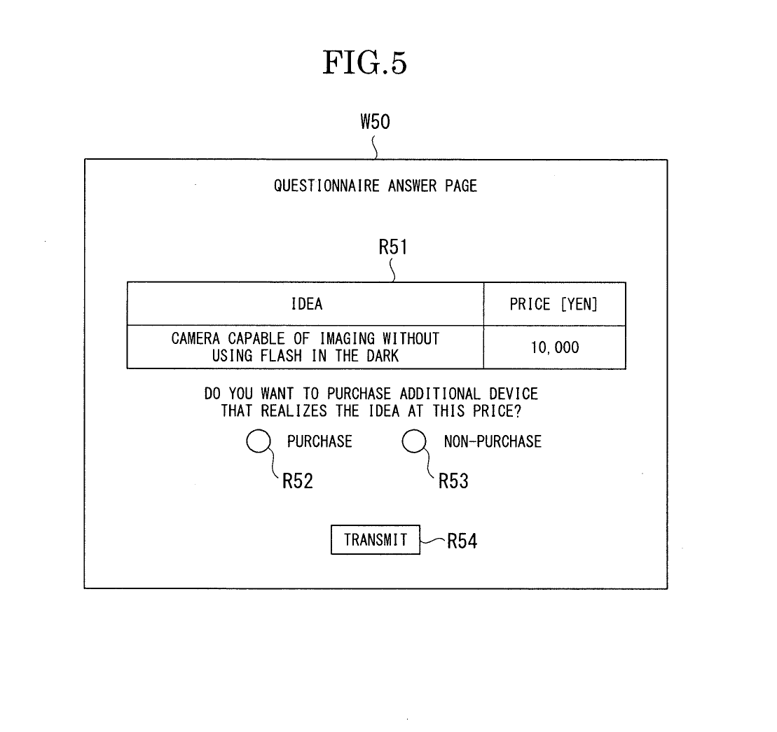

FIG. 5 is a diagram illustrating an example of a browser screen W50 of a questionnaire answer page displayed in the user terminal 100_{—}i. In the browser screen W50 shown in the figure, Table R51 in which an idea and a price are associated with each other is shown. Table R51 shows that the idea corresponds to “camera capable of imaging without using flash in the dark” and the price of an additional device for realizing the idea is 10,000 yen.

Further, in the browser screen W50, a radio button R52 and a radio button R53 are shown. The radio button R52 is a button selected by the user when the user wants to purchase the additional device for realizing the idea at the price. On the other hand, the radio button R53 is a button selected by the user when the user does not want to purchase the additional device for realizing the idea at the price. Thus, the user can alternatively select whether or not to want to purchase the additional device for realizing the idea.

Further, in the browser screen W50, a transmission button R54 is shown. In a state where the radio button R52 is selected, when the cursor is present on the transmission button R54 in the display screen of the display unit 105, if the mouse is left-clicked and the left-click information is input through the input unit 102, the control unit 103 sets a value of purchase desire presence/absence information indicating the presence or absence of the purchase desire to 1, and transmits the purchase desire presence/absence information to the server apparatus 200 through the communication unit 104.

On the other hand, in a state where the radio button R53 is selected, when the cursor is present on the transmission button R54 in the display screen of the display unit 105, if the mouse is left-clicked and the left-click information is input through the input unit 102, the control unit 103 sets the value of the purchase desire presence/absence information to 0, and transmits the purchase desire presence/absence information to the server apparatus 200 through the communication unit 104.

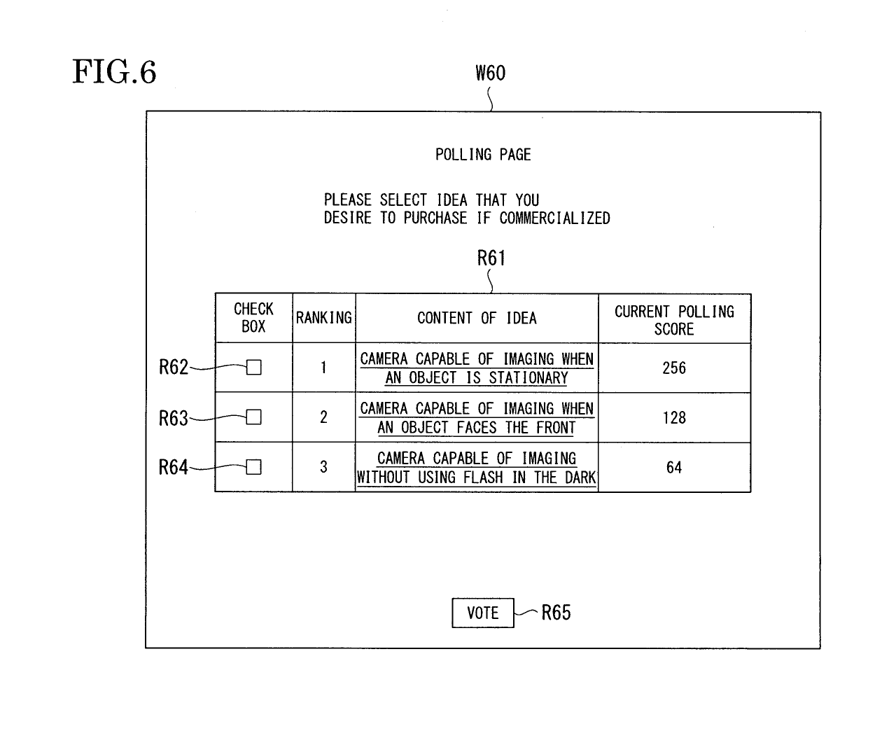

FIG. 6 is a diagram illustrating an example of a browser screen W60 of a polling page displayed in the user terminal 100_{—}i. In the browser screen W60 shown in the figure, Table R61 in which a set of ranking, content of an idea and a current polling score is written is shown. That is, the ranking of each idea based on the current polling score and the content of each idea are shown.

An underline of each idea shown in the column of the content of the idea in Table R61 represents that a link to an improved idea page to which an improved idea of the idea is input is added.

Further, in Table R61, a check box R62, a check box R63 and a check box R64 are shown. Thus, the user can check one box among the three check boxes (R62 to R64), to thereby select one idea from among the three ideas.

Further, in the browser screen W60 shown in the figure, a polling button R65 is shown. In a state where the check box (R62 to R64) is checked, when the cursor is present on the polling button R65, if the mouse is left-clicked and the left-click information is input through the input unit 102, the control unit 103 transmits an idea ID associated with the checked check box (R62 to R64) to the server apparatus 200 through the communication unit 104. Here, the idea ID corresponds to identification information for identifying the idea. Thus, the user terminal 100_{—}i can increase the polling score associated with the idea ID stored in the server apparatus 200 by 1.

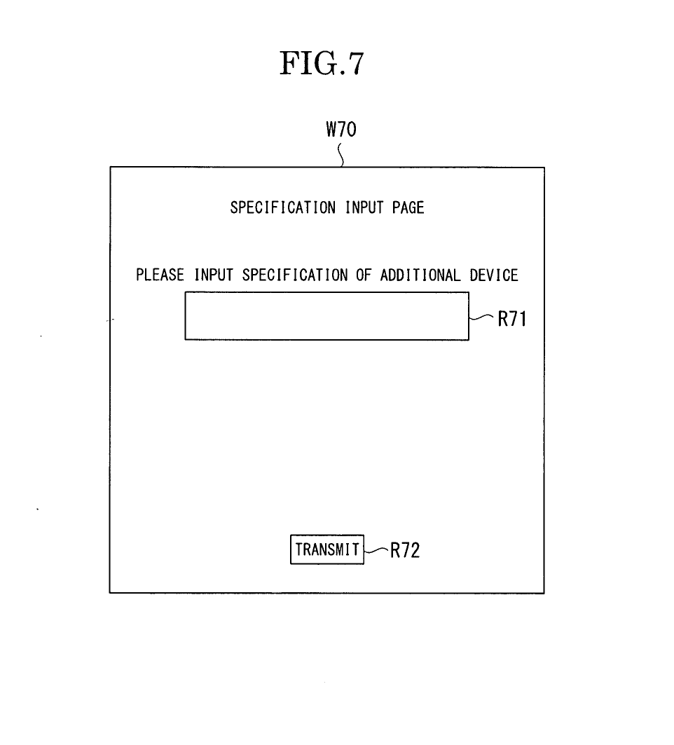

FIG. 7 is a diagram illustrating an example of a browser screen W70 of a specification input page of an additional device displayed in the user terminal 100_{—}i. In the browser screen W70 shown in the figure, an input section R71 in which a specification of the additional device is to be input and a transmission button R72 are shown.

The transmission button R72 is a button for transmitting specification information input in the input section R71 to the server apparatus 200. When the cursor is present on the transmission button R72 in the display screen of the display unit 105, if the mouse is left-clicked and the left-click information is input through the input unit 102, the control unit 103 transmits the specification information indicating the specification of the additional device input in the input section R71 to the server apparatus 200 through the communication unit 104.

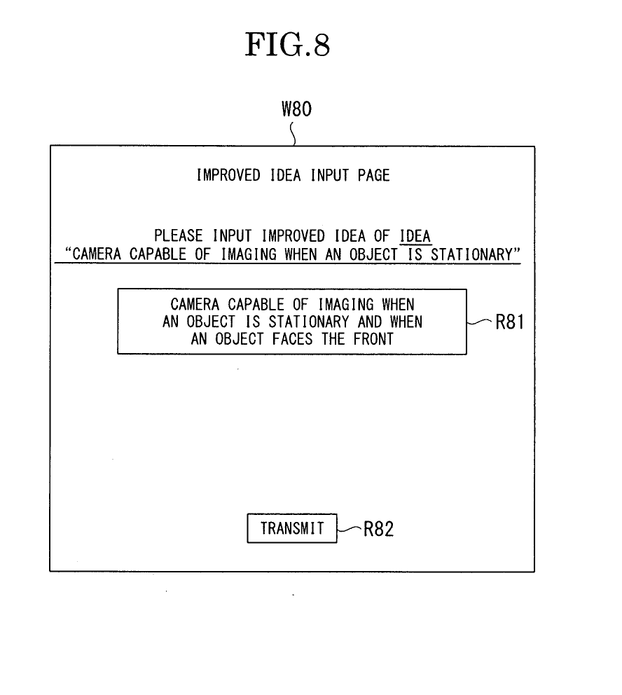

FIG. 8 is a diagram illustrating an example of a browser screen W80 of an improved idea input page for inputting an improved idea of an idea displayed in the user terminal 100_{—}i. In the browser screen W80 shown in the figure, an input section R81 in which the improved idea of the idea is to be input and a transmission button R82 are shown.

The browser screen W80 shown in the figure corresponds to an improved idea input page after being transitioned from a link of “camera capable of imaging when an object is stationary” that is an idea of which the ranking of the browser screen W60 of the polling page in FIG. 6 is the first.

In the example of the browser screen W80 shown in the figure, as an improved idea of the idea of “camera capable of imaging when an object is stationary”, “camera capable of imaging when an object is stationary and when the object faces the front” input in the input section R81 is shown.

Further, the transmission button R82 is a button for transmitting information input in the input section R81 to the server apparatus 200. When the cursor is present on the transmission button R82 in the display screen of the display unit 105, if the mouse is left-clicked and the left-click information is input through the input unit 102, the control unit 103 transmits improved idea information indicating the improved idea input in the input section R81 to the server apparatus 200 through the communication unit 104.

<Schematic Configuration of Manufacturer Terminal>

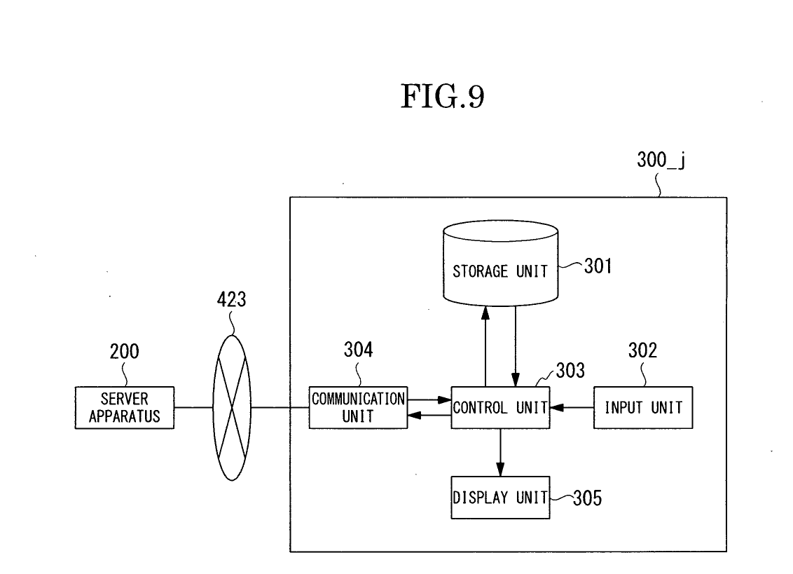

FIG. 9 is a block diagram schematically illustrating a configuration of the manufacturer terminal 300_{—}j in the present embodiment. The manufacturer terminal 300_{—}j includes a storage unit 301, an input unit 302, a control unit 303, a communication unit 304, and a display unit 305. The configuration of the manufacturer terminal 300_{—}j is the same as that of the user terminal 100_{—}i.

In the storage unit 301, a program of an Internet browser executed by the control unit 303 is stored.

The input unit 302 receives input information input by a manufacturer who operates the manufacturer terminal 300_{—}j. The input unit 302 outputs the received input information to the control unit 303. The input unit 302 is a keyboard and a mouse, for example. Specifically, for example, the input unit 302 outputs key input information (for example, idea input information) input through the keyboard to the control unit 303. Further, for example, the input unit 302 outputs cursor movement instruction information for instructing movement of a cursor and left-click information indicating that a mouse is left-clicked to the control unit 303.

The control unit 303 changes the display in the display unit 305 based on the input information input through the input unit 302. Specifically, for example, the control unit 303 moves the position of the cursor displayed in the display unit 305 based on the cursor movement instruction information input through the input unit 302.

Further, the control unit 303 temporarily holds the key input information input through the input unit 302. Further, when the cursor is present on a predetermined button (for example, a radio button, a select box or the like) in a display screen of the display unit 105, the control unit 303 temporarily holds selection information selected by left-click information based on the left-click information input through the input unit 302. Further, the control unit 303 changes the display screen of the display unit 305 based on the left-click information input through the input unit 302.

Further, when the cursor is present on a predetermined button (for example, a select button, a transmit button or the like) in the display screen of the display unit 105, if the left-click information is input through the input unit 302, the control unit 303 transmits the key input information or the selection information that is temporarily held to the server apparatus 200 through the communication unit 304.

Further, the control unit 303 allows the display unit 305 to display a page of the server apparatus 200 based on the information input through the communication unit 304.

The communication unit 304 transmits the key input information or the selection information input from the control unit 303 to the server apparatus 200 under the control of the control unit 303.

The communication unit 304 receives information transmitted from the server apparatus 200, and outputs the received information to the control unit 303.

<Web Page Displayed in Manufacturer Terminal>

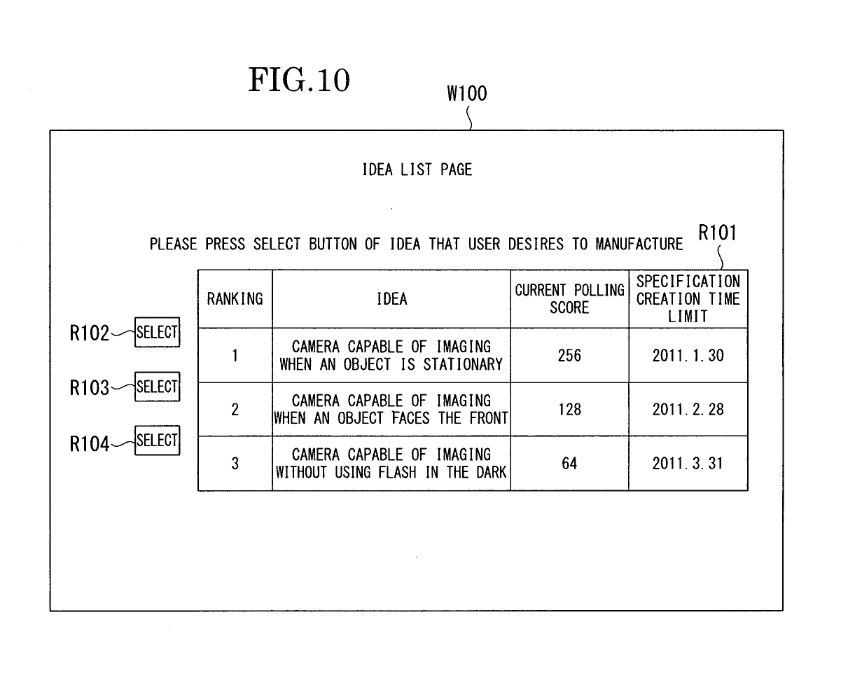

Examples of a Web page displayed in the display unit 305 will be described with reference to FIGS. 10 to 13. FIG. 10 is a diagram illustrating an example of a browser screen W100 of an idea list page displayed in the manufacturer terminal 300_{—}j. In the browser screen W100 shown in the figure, Table R101 indicating an idea list, a select button R102, a select button R103 and a select button R104 are shown.

In Table 8101, a set of idea ranking, an idea, a current polling score and a specification creation time limit is written. In Table R101, an example in which ideas are arranged in the descending order of the idea ranking is shown. Here, the idea ranking is determined based on the current polling score, and is high when the current polling score is high.

When the cursor is present on each select button (R102, R103 or R104) in the display screen of the display unit 305, if the mouse is left-clicked and the left-click information is input through the input unit 302, the control unit 303 transmits an idea ID associated with the select button to the server apparatus 200 through the communication unit 304, and requests a specification input page associated with the select button of the server apparatus 200.

Thus, when receiving the idea ID and the request of the specification input page, the server apparatus 200 transmits specification input page information for generating the specification input page corresponding to the idea ID to the manufacturer terminal 300_{—}j that made the request. The communication unit 304 of the manufacturer terminal 300_{—}j receives the specification input page information transmitted from the server apparatus 200, and outputs the received specification input page information to the control unit 303. The control unit 303 allows the display unit 305 to display the specification input page based on the specification input page information input through the communication unit 304. Thus, the specification input page is displayed in the display unit 305.

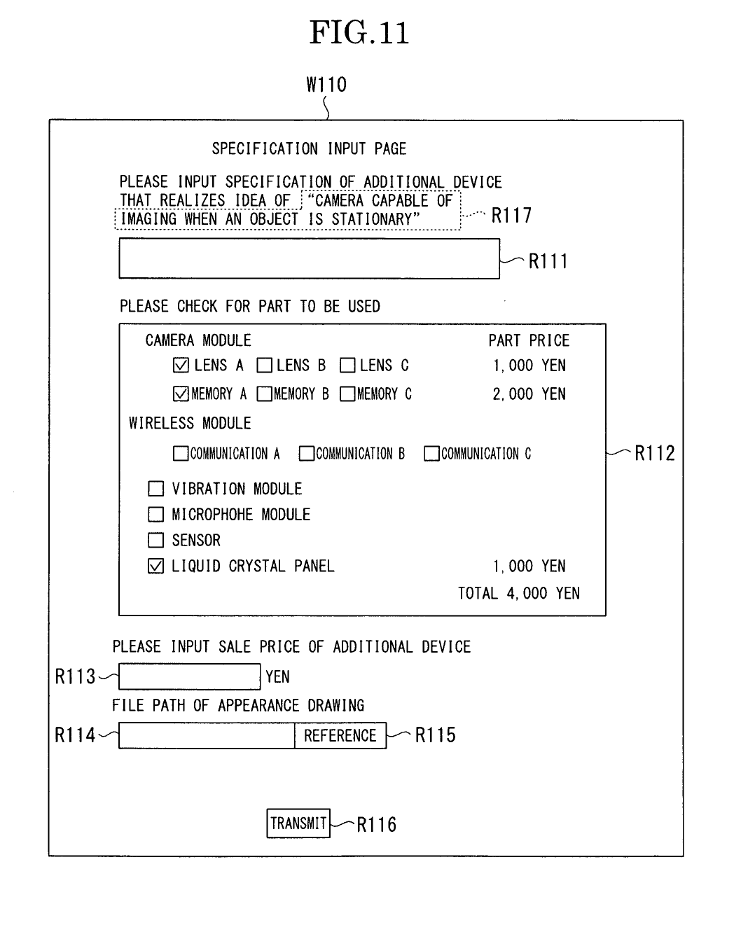

FIG. 11 is a diagram illustrating an example of a browser screen W110 of a specification input page displayed in the manufacturer terminal 300_{—}j. In the browser screen W110 shown in the figure, an input section R111, a check box area R112, an input section R113, an input section 8114, a reference button R115, a transmission button R116 and an idea insert area R117 are shown.

The example shown in FIG. 11 is a specification input page transitioned to by the left-click of the select button R102 corresponding to the idea of “camera capable of imaging when an object is stationary” of which the ranking in Table R101 shown in FIG. 10 is the first.

In the idea insert area R117, a selected idea is inserted.

The input section R111 is an input section in which a specification of an additional device that realizes the idea of “camera capable of imaging when an object is stationary” is to be input.

Further, in the check box area R112, sets of check boxes and part names are sequentially arranged, and a manufacturer of the additional device that operates the manufacturer terminal 300_{—}j can select a part used in the specification of the additional device input in the input section R111. Specifically, as the parts, a check box is present for each of camera modules, communication modules, a vibration module, a microphone module, a sensor and a liquid crystal panel. Thus, the manufacturer of the additional device that operates the manufacturer terminal 300_{—}j can check each check box, to thereby select the part associated with the check box.

Further, when the camera module is used as a part, a check box is present for each lens type (for example, a lens A, a lens B or a lens C) and for each memory type (a memory A, a memory B or a memory C). Further, when the communication module is used as a part, a check box is present for each communication type (for example, communication A, communication B or communication C). For example, the communication A is an infrared communication module, and the communication B is a wireless LAN module.

Thus, the manufacturer of the additional device that operates the manufacturer terminal 300_{—}j can check each check box, to thereby select the lens type, the memory type or the communication type associated with the check box.

In the check box area R112, the check boxes of the lens A, the memory A and the liquid crystal panel are checked. Further, it is shown that, as a part cost, the lens A is 2,000 yen, the memory A is 1000 yen, and the liquid crystal is 1000 yen. Further, it is shown that the total parts cost is 4,000 yen.

If each check box is checked, the manufacturer terminal 300_{—}j transmits the checked part name to the server apparatus 200. The server apparatus 200 reads the part cost associated with the part name transmitted from the manufacturer terminal 300_{—}j, and transmits the part cost to the manufacturer terminal 300_{—}j. The manufacturer terminal 300_{—}j displays the part cost transmitted from the server apparatus 200 in the check box area R112.

Thus, since the manufacturer terminal 300_{—}j displays the cost of the part of which the check box is checked, the manufacturer of the additional device that operates the manufacturer terminal 300_{—}j can recognize the cost of the part. Thus, the manufacturer of the additional device can form a scheme of a sale price of the additional device based on the part cost.

The input section R113 is an input section in which the sale price of the additional device is to be input.

The manufacturer terminal 300_{—}j may display the sale price scheme of the additional device in the input section R113 based on the total part cost. In this case, the server apparatus 200 calculates the total parts cost and obtains the sale price scheme by multiplying the calculated total parts cost by a predetermined sale factor (for example, 1.5 times). The server apparatus 200 transmits the calculated sale price scheme to the manufacturer terminal 300_{—}j. The manufacturer terminal 300_{—}j displays the part cost transmitted from the server apparatus 200 in the check box area R112.

The input section R114 is an input section in which a file path of an appearance drawing of the additional device is to be input. The reference button R115 is a button for supporting an input of the file path. When the cursor is present on the reference button RI 15 in the display screen of the display unit 305, if the mouse is left-clicked and the left-click information is input through the input unit 302, the control unit 303 allows the display unit 305 to display a selection screen of a file. In the display screen of the display unit 305, when the cursor is present on a file name displayed in the screen, if the mouse is left-clicked and the left-click information is input through the input unit 302, the control unit 303 displays the path of the file selected by the left-click in the input section R113.

The transmission button R116 is a button for transmitting the information input in the specification input page to the server apparatus 200. When the cursor is present on the transmission button R116 in the display screen of the display unit 305, if the mouse is left-clicked and the left-click information is input through the input unit 302, the control unit 303 transmits information indicating the specification of the additional device, the part to be used and the sale price, respectively, and the file of the appearance drawing to the server apparatus 200 through the communication unit 304.

Thus, the server apparatus 200 receives the information input in the specification input page and the file of the appearance drawing transmitted from the manufacturer terminal 300_{—}j, and stores the information indicating the specification of the additional device, the part to be used, and the sale price, respectively, the file of the appearance drawing and a manufacturer ID for identifying a specification creator in association with the idea ID.

Further, when receiving a user ID of a user who contributes an idea of the idea ID and a request of the specification selection page, the server apparatus 200 reads information indicating the specification of the additional device, the appearance drawing, the part list, the price and the manufacturer ID associated with the idea ID, respectively, from a storage unit 210 of the apparatus to be described later. Further, the server apparatus 200 reads information indicating a manufacturer name associated with the read manufacturer ID from the storage unit 210. Further, the server apparatus 200 reads a source code of the specification selection page from the storage unit 210.

Further, the server apparatus 200 inserts the read specification of the additional device, appearance drawing, part list, price and manufacturer ID in predetermined places in the source code of the specification selection page. Further, the server apparatus 200 transmits specification selection page information indicating the specification selection page changed by the insertion to the user terminal 100_{—}i. Thus, the user terminal 100_{—}i can display the specification selection page (for example, shown in FIG. 4) based on the received specification selection page information.

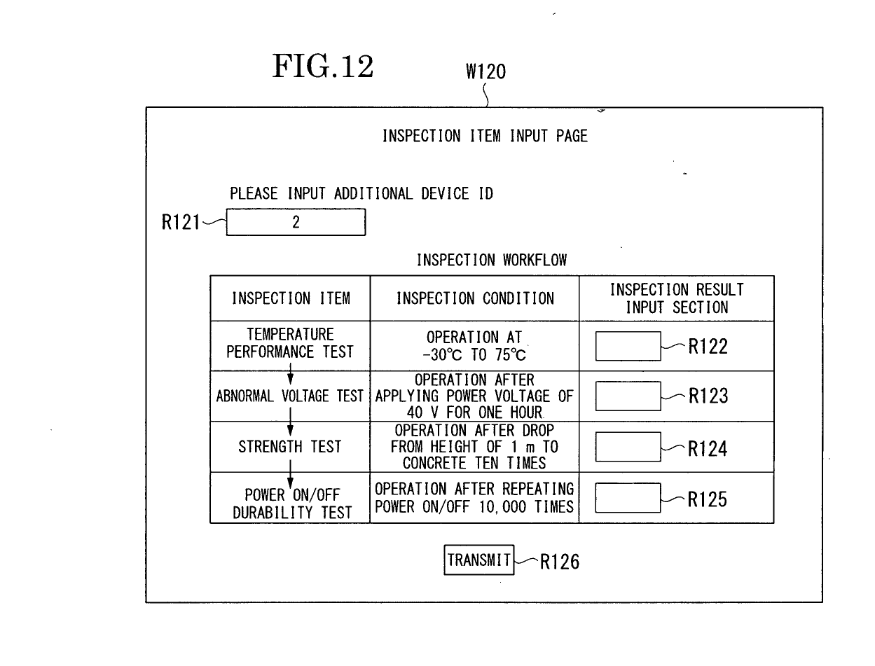

FIG. 12 is a diagram illustrating an example of a browser screen W120 of an inspection item input page of an additional device displayed in the manufacturer terminal 300_{—}j. In the browser screen W120 shown in the figure, an input section R121, a table that indicates an inspection work flow and a transmission button R126 are shown. In the table that indicates the inspection work flow, a set of an inspection item, an inspection condition and an input section of an inspection result obtained by inspecting the inspection item under the inspection condition is shown. Further, it is shown that the respective inspection items are inspected in the order indicated by arrows.

The input section R121 is an input section in which an additional device ID that identifies the additional device is to be input. Here, as an example, a state where “2” is input in the input section R121 is shown. An input section R122 is an input section in which an inspection result (hereinafter, referred to as a temperature performance test result) obtained by a temperature performance test is to be input. An input section R123 is an input section in which an inspection result (hereinafter, referred to as an abnormal voltage test result) obtained by an abnormal voltage test is to be input. An input section R124 is an input section in which an inspection result (hereinafter, referred to as a strength test result) obtained by a strength test is to be input. An input section R125 is an input section in which an inspection result (hereinafter, referred to as a power ON/OFF durability test result) obtained by a power ON/OFF durability test is to be input.

Here, for example, in each inspection result, 1 is input if a corresponding inspection condition is satisfied, and 0 is input if the corresponding inspection condition is not satisfied. Specifically, for example, the power ON/OFF durability test result represents a value indicating whether a power source is not broken when turning ON and OFF of the power source is repeated a predetermined number of times (for example, 10000 times). If the value is 1, it means that the power source is not broken (has the durability), and if the value is 0, it means that the power source is broken (does not have the durability). The transmission button R126 is a button for transmitting information input in the input sections R121 to R125 to the server apparatus 200.

When the cursor is present on the transmission button R125 in the display screen of the display unit 305, if the mouse is left-clicked and the left-click information is input through the input unit 302, the control unit 303 transmits the information indicating the additional device ID input in the input section R121, the temperature performance test result input in the input section R122, the abnormal voltage test result input in the input section R123, the strength test result input in the input section R124 and the power ON/OFF durability test result input in the input section R125 to the server apparatus 200 through the communication unit 304, respectively.

Thus, the server apparatus 200 stores the information indicating the additional device ID, the temperature performance test result, the abnormal voltage test result, the strength test result and the power ON/OFF durability test result transmitted from the manufacturer terminal 300_{—}j, respectively. Here, the server apparatus 200 stores a predetermined appropriate range for each inspection item.

The server apparatus 200 determines whether or not each of the received inspection items is in the predetermined appropriate range for each inspection item with reference to the stored appropriate range for each inspection item. If all the inspection items are in the appropriate ranges, the server apparatus 200 determines that the additional device associated with the additional device ID is authenticated. On the other hand, if any inspection item is not in the appropriate range, the server apparatus 200 determines that the additional device associated with the additional device ID is not authenticated.

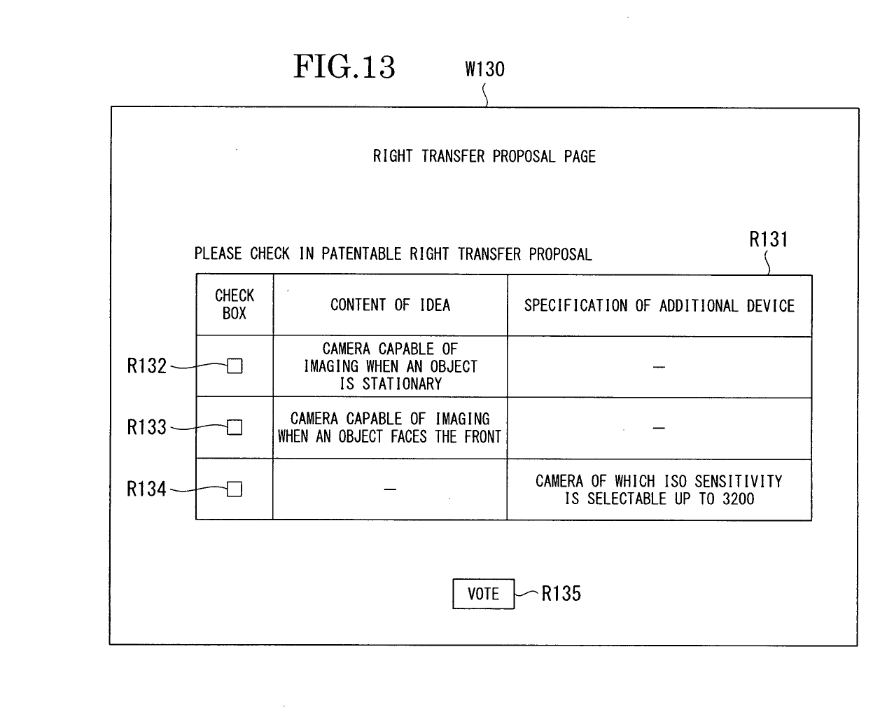

FIG. 13 is a diagram illustrating an example of a browser screen W130 of a patentable right transfer proposal page displayed in the manufacturer terminal 300_{—}j. In the browser screen W130 shown in the figure, Table R131 and a transmission button R135 are shown. Further, in Table R131, a check box R132, a check box R133 and a check box R134 are shown.

In Table R131, a set of an idea uploaded to the server apparatus 200 by a user or a specification of an additional device uploaded to the server apparatus 200 by the user, and the check box (R132, R133 or R134) is shown. For example, a set of the check box R132 and the idea of “camera capable of imaging when an object is stationary” is shown.

The transmission button R135 is a button for transmitting an idea ID or a specification ID associated with the idea or the specification of the additional device checked in the check boxes R132 to R134 to the server apparatus 200. Here, the specification ID is identification information for identifying the additional device.

When the cursor is present on the transmission button R135, if the mouse is left-clicked and the left-click information is input through the input unit 302, the control unit 303 transmits idea flag information indicating whether the checked check box corresponds to the idea or the configuration of the additional device (for example, an idea flag of 1 represents the idea, and an idea flag of 0 represents the configuration of the additional device) to the server apparatus 200 through the communication unit 304.

Further, if the checked check box corresponds to the idea, the control unit 303 transmits the idea ID associated with the idea to the server apparatus 200 through the communication unit 304, and if the checked check box corresponds to the configuration of the additional device, the control unit 303 transmits the configuration ID associated with the configuration to the server apparatus 200 through the communication unit 304.

<Schematic Configuration of Server Apparatus>

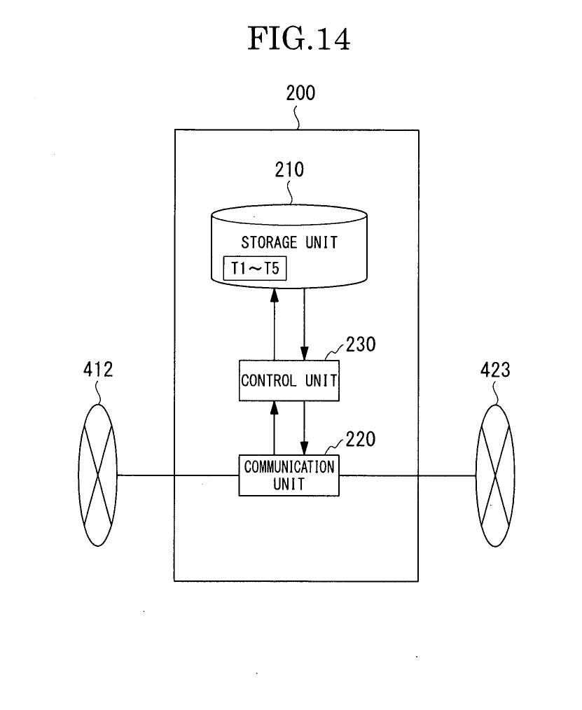

Next, the server apparatus 200 in the present embodiment will be described. FIG. 14 is a block diagram schematically illustrating a configuration of the server apparatus 200 in the present embodiment. The server apparatus 200 includes a storage unit 210, a communication unit 220, and a control unit 230.

In the storage unit 210, page information is stored. Specifically, for example, in the storage unit 210, user registration page information indicating a source code of a user registration page and manufacturer registration page information indicating a source code of a manufacturer registration page are stored. Further, in the storage unit 210, idea input page information indicating a source code of an idea input page (for example, shown in FIG. 3) for idea input is stored. Further, in the storage unit 210, idea page information indicating a source code of an idea page for displaying an idea uploaded to the server apparatus 200 is stored.

Further, in the storage unit 210, specification selection page information indicating a source code of a specification selection page (for example, shown in FIG. 4) for specification selection of a user is stored. Further, in the storage unit 210, questionnaire answer page information indicating a source code of a questionnaire answer page (for example, shown in FIG. 5) for a questionnaire answer of a user is stored. Further, in the storage unit 210, polling page information indicating a source code of a polling page (for example, shown in FIG. 6) for a user's voting for an idea that leads to a purchase desire of the user when being commercialized is stored.

Further, in the storage unit 210, sale page information of an additional device indicating a source code of an additional device sale page for an additional device sale is stored. Further, in the storage unit 210, specification input page information indicating a source code of a specification input page (for example, shown in FIG. 7) for inputting a specification of an additional device is stored.

Further, in the storage unit 210, improved idea input page information indicating a source code of an improved idea input page (FIG. 8) for inputting an improved idea of an idea is stored.

Further, in the storage unit 210, idea list page information indicating a source code of an idea list page (for example, shown in FIG. 10) where ideas are displayed in the order of ranking based on the poll is stored. Further, in the storage unit 210, specification input page information indicating a source code of a specification input page (for example, shown in FIG. 11) for inputting a specification of an additional device that realizes an idea is stored.

Further, in the storage unit 210, inspection item input page information indicating a source code of an inspection item input page (for example, shown in FIG. 12) for inputting an inspection item of an additional device is stored. Further, in the storage unit 210, right transfer proposal page information indicating a source code of a right transfer proposal page (for example, shown in FIG. 13) for patentable right transfer proposal is stored.

Further, in the storage unit 210, a variety of information is stored by the control unit 230.

The communication unit 220 receives a variety of information transmitted from the user terminal 100_{—}i through the communication network 412, and outputs the variety of received information to the control unit 230. Further, the communication unit 220 transmits the variety of information input from the control unit 230 to the user terminal 100_{—}i through the communication network 412.

Further, the communication unit 220 receives a variety of information transmitted from the manufacturer terminal 300_{—}j through the communication network 423, and outputs the variety of received information to the control unit 230. Further, the communication unit 220 transmits the variety of information input from the control unit 230 to the manufacturer terminal 300_{—}j through the communication network 423.

The control unit 230 stores the variety of information input through the communication unit 220 in the storage unit 210. Further, the control unit 230 reads, when a registration page request transmitted from the user terminal 100_{—}i is input through the communication unit 220, the registration page information from the storage unit 210. The control unit 230 transmits the registration page information to the user terminal 100_{—}i that made the request through the communication unit 220.

Further, the control unit 230 generates, when information indicating a login password, a name, an address, a mail address and a bank account transmitted from the user terminal 100_{—}i is input through the communication unit 220, a user ID that is intrinsic identification information for identifying a corresponding user. Further, the control unit 230 stores the generated user ID in association with the input login password, name, address, mail address and bank account in Table T1 of the storage unit 210.

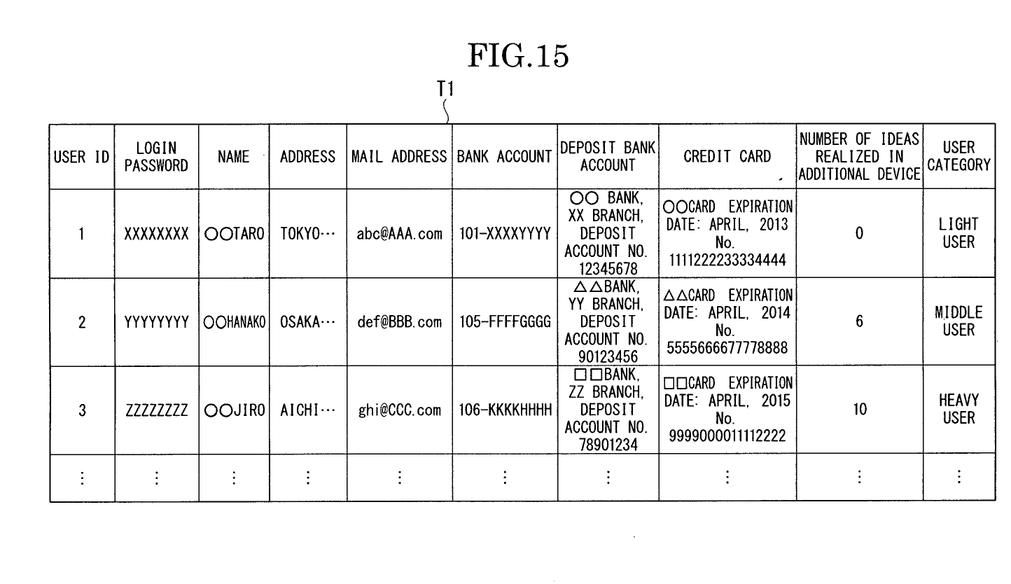

FIG. 15 is a diagram illustrating an example of Table T1 in which the user registration information stored in the storage unit 210 is shown. In Table T1 shown in the figure, a set of a user ID, a login password, a name, an address, a mail address, a deposit bank account, a credit card, the number of ideas realized in an additional device and a user category is written.

For example, with respect to a user having a user ID “1”, it is shown that the login password is “XXXXXXXX”, the name is “OO Taro”, the address is “Tokyo . . . ”, the mail address is “abc@AAA.com”, the deposit bank account is “OO bank, XX branch, savings account No. 12345678”, the credit card is “OO card, expiration date: April, 2013, No. 1111222233334444”, the number of ideas realized in the additional device is “0”, and the user category is “light user”.

In the user registration, the control unit 230 sets the number of ideas realized in the additional device to “0”, and sets the user category to “light user”.

If the commercialization of a certain idea is determined, the control unit 230 makes reference to a user ID associated with an idea ID of the idea in Table T3 in which idea information to be described later is stored. Further, the control unit 230 increases the number of ideas realized in the additional device by 1 with respect to the referenced user ID, in Table T1 in which the user registration information is stored. Thus, the control unit 230 can update the number of ideas realized in the additional device.

Further, if the number of ideas realized in the additional device is equal to or greater than a first threshold value (for example, 5), the user category associated with the user ID is changed to a middle user. Further, if the number of ideas realized in the additional device is equal to or greater than a second threshold value (for example, 10) which is greater than the first threshold value, the user category associated with the user ID is changed to a heavy user.

That is, the control unit 230 changes the user category of the user based on the number of ideas realized in the additional device.

In the present embodiment, the change of the user category by means of the control unit 230 is performed based on the number of ideas realized in the additional device, but the invention is not limited thereto, and may be performed based on the number of ideas provided for a mass-produced additional device.

A user who uses a hardware development kit (hereinafter, referred to as an HDK) necessary for development of an additional device may be an end user, may be a user who wants to create the additional device, or may be a manufacturing company of the additional device. Here, the HDK refers to an environmental kit for product development of the additional device. Specifically, for example, the FMK is a mechanical and electrical interface for connecting a base terminal to the additional device, which includes “technical information (including software and various documents)” and a “part kit (basic module)”.

In the present embodiment, the light user usually purchases a completed additional device without using the HDK kit. On the other hand, the heavy user is a user who is capable of creating or customizing an additional device using the HDK kit. Further, the middle user is positioned between the light user and the heavy user.

The technical information includes contact information (current rating information or voltage rating information), communication standard information (protocol, communication speed and communication capacity), a set of commands or functions usable in software development of an additional device (Application Program I/F (API)) or the like, for example.

The part kit includes a mechanical mount that connects the base terminal to the additional device, IC chips, communication parts or the like, for example.

The control unit 230 determines a user level (additional device manufacturing technique) (1) according to payment of money (registration fee) from the user, (2) according to the number of generated ideas, (3) according to the number of points given by the generated ideas or according to the number of commercialized ideas.

The control unit 230 differentiates the HDK to be provided according to the user level. Specifically, for example, the control unit 230 provides an IC chip having high performance for use when the user level increases. Alternatively, the control unit 230 provides a communication module having excellent communication parameters (for example, high communication speed, long communication distance and high communication sensitivity) when the user level increases. Alternatively, the control unit 230 provides an API having a special function when the user level increases.

Thus, since the server apparatus 200 sets plural user levels and differentiates the specification of the HDK to be provided for each user level, it is possible to provide motivation for increasing a manufacturing frequency or a manufacturing effort for an additional device to a manufacturer.

Returning to FIG. 14, the control unit 230 reads, when the manufacturing registration page request transmitted from the manufacturer terminal 300_{—}j is input through the communication unit 220, the manufacturing registration page information from the storage unit 210. The control unit 230 transmits the registration page information to the manufacturer terminal 300_{—}j that made the request through the communication unit 220.

Further, the control unit 230 generates, when the information indicating the login password, the manufacturer name, the mail address and the manufacturer category transmitted from the manufacturer terminal 300_{—}j is input through the communication unit 220, a manufacturer ID that is intrinsic identification information for identifying the manufacturer. Here, the manufacturer category refers to a category of manufacturers selected by the manufacturer. The manufacturer category includes a general enterprise, a power user who individually manufactures an additional device, a management enterprise that manufactures a base terminal, a consigned enterprise that manufactures a base terminal or an additional device according to consignment of the management enterprise, or the like, for example.

Further, the control unit 230 stores the generated manufacturer ID in association with the input login password, manufacturer name, mail address and manufacturer category in Table T2 of the storage unit 210.

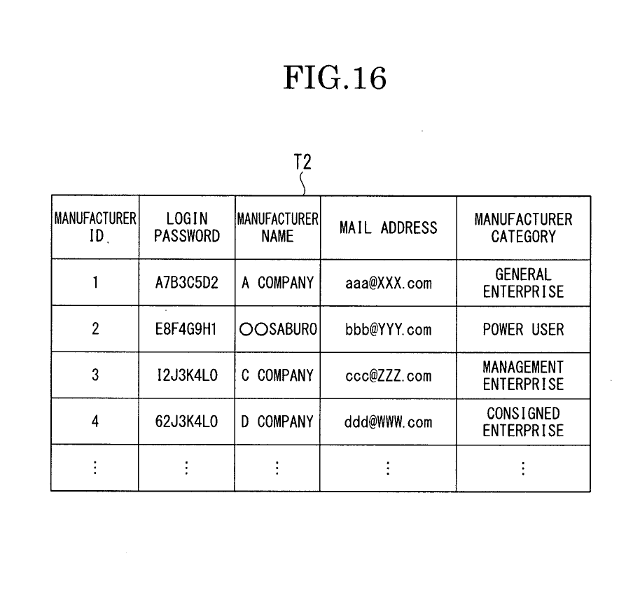

FIG. 16 is a diagram illustrating an example of Table T2 in which the manufacturer registration information stored in the storage unit 210 is written. In Table T2 shown in the figure, a set of a manufacturer ID, a login password, a manufacturer name, a mail address and a manufacturer category is written. For example, with respect to a manufacturer having a manufacturer ID of “1”, it is shown that the login password is “A7B3C5D2”, the manufacturer name is “A company”, the mail address is “aaa@XXX.com”, and the manufacturer category is “general enterprise”.

The manufacturer includes individuals in addition to companies. If the manufacturer is an individual, an individual's name is stored in the item of the manufacturer name in Table T2.

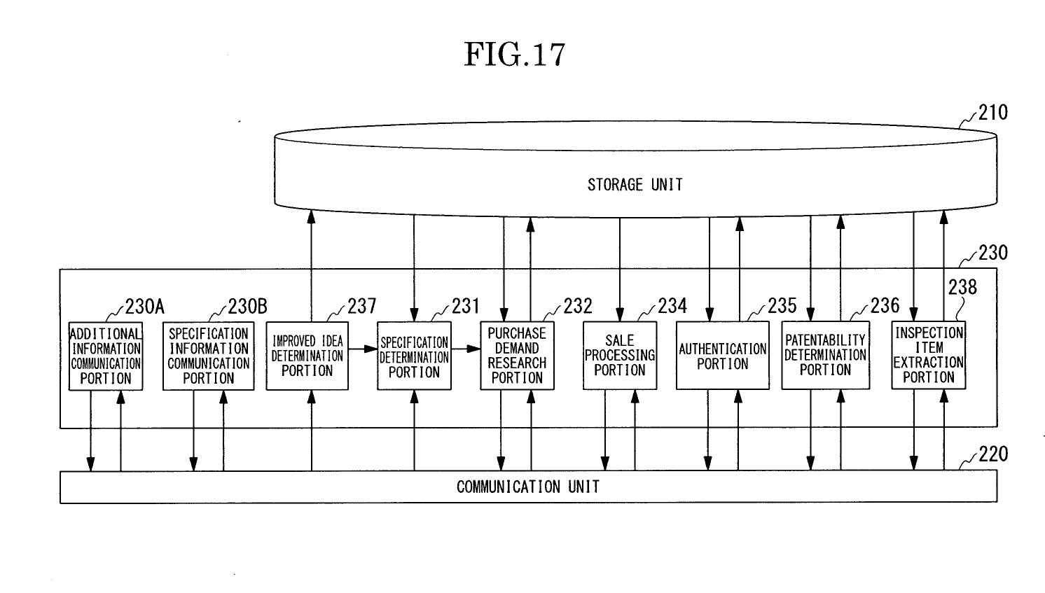

FIG. 17 is a block diagram schematically illustrating a configuration of the control unit 230. The control unit 230 includes an additional information communication portion 230A, a specification information communication portion 230B, a specification determination portion 231, a purchase demand research portion 232, a sale processing portion 234, an authentication portion 235, a patentability determination portion 236, an improved idea determination portion 237, and an inspection item extraction portion 238.

The additional information communication portion 230A transmits, when the communication unit 220 receives additional function information indicating a function to be added to a basic device from the user terminal 100_{—}i, the additional function information to the manufacturer terminal 300j through the communication unit 220.

The specification information communication portion 230B transmits, when the communication unit 220 receives specification information indicating a specification of the additional device for realizing the function from the manufacturer terminal 300_{—}j, the specification information to the user terminal 100_{—}i through the communication unit 220.

Here, the specification information includes a part list that is a list of parts for manufacturing the additional device. The part list includes a basic module that is necessarily used when the additional device is manufactured, and a selective module that is selectively used.

The basic module includes a connection member that connects the basic device to the additional device. Further, the selective module includes at least one of a device that forms a photographing device, a vibration device, a microphone, a sensor and a display panel.

The specification determination portion 231 reads, when the idea input page request transmitted from the user terminal 100_{—}i is input through the communication unit 220, the idea input page from the storage unit 210. Further, the specification determination portion 231 transmits the read idea input page information to the user terminal 100_{—}i that requests the page through the communication unit 220.

Further, the specification determination portion 231 generates, when the idea information, the mass production desire presence/absence information, the specification creation time limit information and the user ID of the user who provides the idea indicated by the idea information transmitted from the user terminal 100_{—}i are input through the communication unit 220, an idea ID for identifying the idea indicated by the idea information.

Further, the specification determination portion 231 associates and stores the input information indicating the idea ID, the user ID, the idea, the presence or absence of the mass production desire and the specification creation time limit, respectively, in Table T3 of the storage unit 210. Further, here, the specification determination portion 231 sets a polling score associated with a newly stored idea ID to 0, and inputs neither a value to the parent idea ID nor a novelty flag associated with the idea ID.

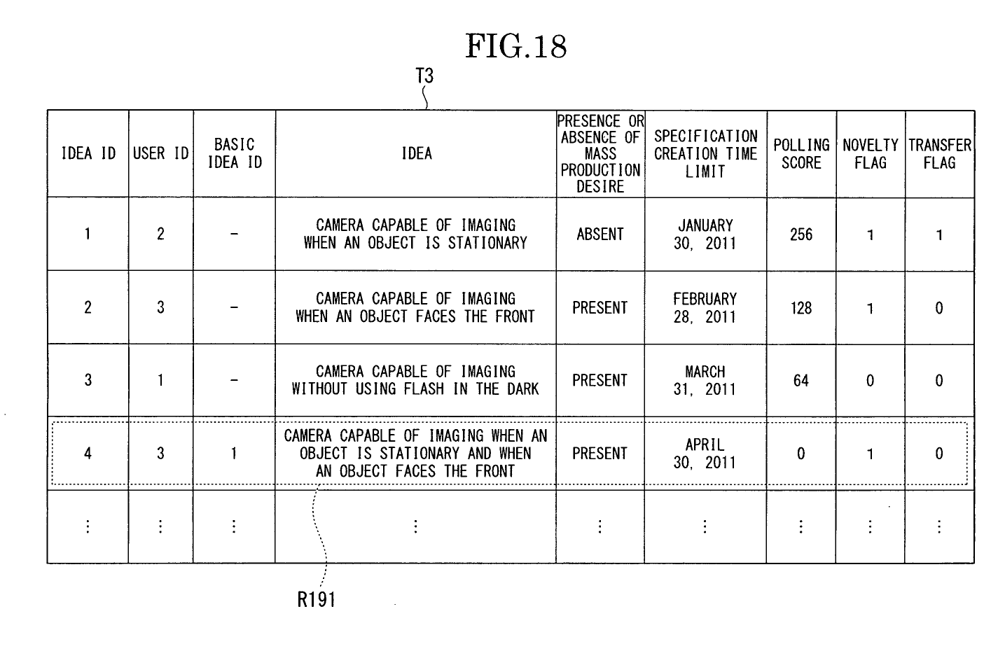

FIG. 18 is a diagram illustrating an example of Table T3 in which idea information stored in the storage unit 210 is written. In Table T3 shown in the figure, each set of an idea ID, a user ID, a parent idea ID, an idea, the presence or absence of a mass production desire, a specification creation time limit, a polling score, a novelty flag and a transfer flag is written.

It is shown that, for example, when the idea ID is “1”, the user ID is “2”, the parent idea ID has no value, the idea is “camera capable of imaging when an object is stationary”, the presence or absence of the mass production desire is “absent”, the use creation time limit is “Jan. 30, 2011”, the polling score is “256”, the novelty flag is “1”, and the transfer flag is “1”.

Here, the polling score refers to a score obtained from users who desire to purchase a product when the product is commercialized from the idea associated with the polling score.

The novelty flag is information indicating whether or not novelty is present in the idea associated with the novelty flag. The novelty flag shows 1 when novelty is present in the idea associated with the novelty flag, and shows 0 when novelty is not present in the idea.

Further, the transfer flag is information indicating whether or not a patentable right for the idea associated with the transfer flag is transferred from the user who contributes the idea to an enterprise of which the manufacturer category is the management enterprise. The transfer flag shows 1 when the patentable right for the idea is transferred, and shows 0 when the patentable right for the idea is not transferred.

Further, a basic idea ID refers to an idea ID of an idea that is an improvement target, given to an idea to be improved. As shown in an area R191 in FIG. 18, an idea of which the idea ID is 4 is an improved idea of an idea of which the idea ID is 1. Thus, 1 is shown as the basic idea ID of the idea of which the idea ID is 4.

The control unit 303 generates an idea ID when the basic idea ID, the improved idea input user ID, the improved idea information, the mass production desire presence/absence information and the specification creation time limit information transmitted from the user terminal 100_{—}i are input through the communication unit 220. Further, the control unit 303 stores the generated idea ID in association with the improved idea input user ID, the basic idea ID that is the improvement target, the improved idea information, the mass production desire presence/absence information and the specification creation time limit information in Table T3 of the storage unit 210.

Returning to FIG. 17, the specification determination portion 231 reads, when the idea page request transmitted from the manufacturer terminal 300_{—}j is input through the communication unit 220, the idea page information from the storage unit 210. Further, the specification determination portion 231 transmits the read idea page information to the manufacturer terminal 300_{—}j through the communication unit 220.

The specification determination portion 231 reads, when the selected idea ID transmitted from the manufacturer terminal 300_{—}j is input through the communication unit 220, the specification input page information from the storage unit 210. Here, the selected idea ID is identification information for identifying the idea selected by the manufacturer. Further, the specification determination portion 231 changes the specification input page indicated by the specification input page information according to the selected idea ID. Specifically, for example, the specification determination portion 231 reads the idea information corresponding to the input selected idea ID from Table T3 of the storage unit 210. Further, the specification determination portion 231 inserts the idea indicated by the read idea information in a place of the source code of the specification input page.

The above process will be described with reference to the example of the browser screen W110 shown in FIG. 11. The specification determination portion 231 reads, when the idea ID indicating 1 is input, “camera capable of imaging when an object is stationary” that is the idea associated with the idea ID “1” from Table T3 of the storage unit 210. Further, the specification determination portion 231 inserts the idea of “camera capable of imaging when an object is stationary” in a place of the source code of the specification input page read from the storage unit 210.

Further, the specification determination portion 231 transmits specification input page information indicating the source code of the specification input page changed by the insertion to the manufacturer terminal 300_{—}j through the communication unit 220.

Thus, in the manufacturer terminal 300_{—}j, “camera capable of imaging when an object is stationary” that is the idea corresponding to the idea ID “1” is displayed in the specification input page, as in the browser screen W110 shown in FIG. 11. Thus, when inputting the specification of the idea, the manufacturer who operates the manufacturer terminal 300_{—}j can input the specification while checking the selected idea, and thus, it is possible to reduce errors of specification input for a wrong idea.

The specification determination portion 231 generates a specification ID that is identification information intrinsic to the specification when the idea ID, the manufacturer ID, the file of the appearance drawing, the part list information, the specification information and the price information transmitted from the manufacturer terminal 300_{—}j are input through the communication unit 220. Further, the specification determination portion 231 stores the input file of the appearance drawing in the storage unit 210, and obtains a file path of the appearance drawing stored in the storage unit 210.

The specification determination portion 231 associates the information indicating the specification ID, the idea ID, the manufacturer ID, the file path of the appearance drawing, the part list, the specification and the price, respectively, with each other and stores the associated information in Table T4 of the storage unit 210.

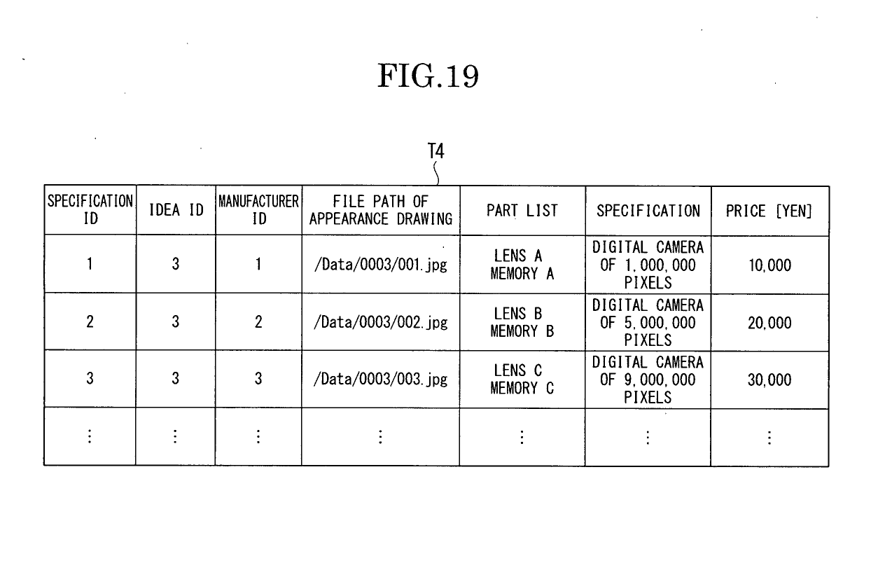

FIG. 19 is a diagram illustrating an example of Table T4 in which the specification information stored in the storage unit 210 is written. In Table T4 shown in the figure, each set of a specification ID, an idea ID, a manufacturer ID, a file path of an appearance drawing, a part list, a specification and a price is written. It is shown that, for example, when the specification ID is “1”, the idea ID is “1”, the manufacturer ID is “1”, the file path of the appearance drawing is “/Data/0003/001.jpg”, the part list is “lens A and memory A”, the specification is “digital camera of 1,000,000 pixels”, and the price is “10,000” yen.

Returning to FIG. 17, the specification determination portion 231 determines whether or not the idea specification creation time limit is expired. If the specification creation time limit is expired, the specification determination portion 231 reads a user ID associated with the idea ID of the idea from Table T3 stored in the storage unit 210. Further, the specification determination portion 231 reads the mail address information associated with the user ID from Table T1 stored in the storage unit 210.

Further, the specification determination portion 231 transmits a mail indicating that the specification creation time limit set to the idea of the idea ID is expired to the read main address. Thus, the specification determination portion 231 can notify the user who contributes the idea that the idea specification creation time limit is expired.

The specification determination portion 231 reads, when the idea ID and the request of the specification selection page (for example, shown in FIG. 4) of the idea indicated by the idea ID transmitted from the user terminal 100_{—}i are input through the communication unit 220, the source code of the specification selection page from the storage unit 210. Further, specification determination portion 231 extracts information indicating the specification associated with the input idea ID, the file path of the appearance drawing, the part list and the price, respectively, from Table T4 of the storage unit 210.

Further, the specification determination portion 231 inserts the specification, the file path of the appearance drawing, the part list and the price indicated by the extracted information in the source code of the specification selection page. Further, the specification determination portion 231 transmits the specification selection page information indicating the source code of the specification selection page changed by the insertion to the terminal 100_{—}i that made the request through the communication unit 220.

Specifically, for example, in the example of Table T4 shown in FIG. 19, if the input idea ID is 3, the specification determination portion 231 reads information indicating three sets of the specification creation name, the appearance drawing, the part list, the specification and the price, respectively, associated with the idea ID of 3.

The specification determination portion 231 inserts the specification creation name, the appearance drawing, the part list, the specification and the price indicated by the read information in the source code of the specification selection page, to thereby generate a source code of a specification selection page that generates the browser screen W40 shown in FIG. 4. Further, the specification determination portion 231 transmits the specification selection page information indicating the source code of the generated specification selection page to the terminal 100_{—}i that made the request through the communication unit 220.

The specification determination portion 231 determines, when the specification information (hereinafter, referred to as selection information) selected from the user terminal 100_{—}i is input through the communication unit 220, that an additional device with the selected specification information is to be created. Further, the specification determination portion 231 generates an additional device ID for identifying the additional device. Further, the specification determination portion 231 stores the specification information in association with the information indicating the additional device ID, the idea ID, the manufacturer ID, the file path of the appearance drawing, the part list and the price, respectively, in Table T5 of the additional device information of the storage unit 210.

As described above, the specification determination portion 231 determines, when the selection information indicating one specification selected from the specifications indicated by the specification information transmitted to the user terminal 100_{—}i is received from the user terminal 100_{—}i through the communication unit 220, the one specification indicated by the selection information as the specification of the additional device. Thus, the specification determination portion 231 can determine the specification of the additional device to be realized by associating a function to be added by the user with the base terminal.

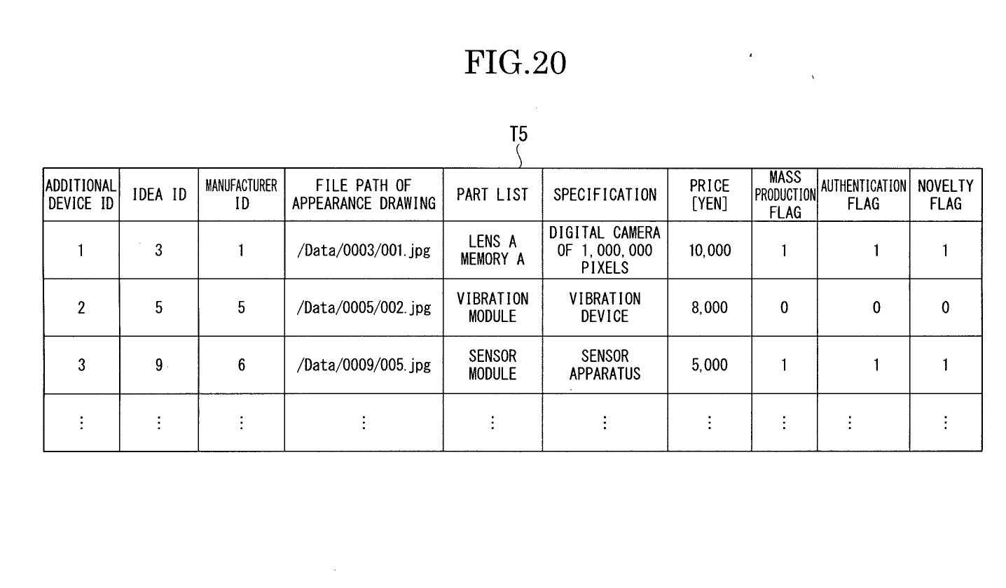

FIG. 20 illustrates an example of Table T5 in which the additional device information stored in the storage unit 210 is written. In Table T5 shown in the figure, each set of an additional device ID, an idea ID, a manufacturer ID for identifying a manufacturer who creates a specification of an additional device of an additional device ID, a file path of an appearance drawing, a part list, a specification, a price, a mass production flag, an authentication flag and a novelty flag is written. For example, when the additional device ID is 1, the idea ID is “1”, the manufacturer ID is “1”, the file path of the appearance drawing is “/Data/0003/001.jpg”, the part list is “lens A, memory A”, the specification is “digital camera of 1,000,000 pixels”, the price is “10,000” yen, the mass production flag is “1”, the authentication flag is “1”, and the novelty flag is “1”.

Here, the mass production flag refers to a flag that indicates whether or not to perform mass production. If the additional device of the additional device ID associated with the mass production flag is mass-produced, the mass production flag is 1, and if the additional device of the additional device ID associated with the mass production flag is not mass-produced, that is, if the additional device is a special order product, the mass production flag is 0.

Further, the authentication flag refers to a flag that indicates whether or not the additional device satisfies predetermined standards. If the additional device of the additional device ID associated with the authentication flag satisfies the predetermined standards, the authentication flag is 1, and if the additional device does not satisfy the predetermined standards, the authentication flag is 0.

Further, the novelty flag refers to a flag that indicates whether or not novelty is present in the additional device. If novelty is present in the additional device of the additional device ID, the novelty flag is 1, and if novelty is not present in the additional device, the novelty flag is 0.

Under the assumption that the mass production desire presence/absence information indicating whether or not a mass production desire is present for an additional device that realizes an additional function received from the user terminal 100_{—}i is stored in the storage unit 210 in advance, a change process of the mass production flag in Table T5 stored in the storage unit 210 will be described.

When the specification of the additional device is determined by the specification determination portion 231, the purchase demand research portion 232 researches, when the mass production desire presence/absence information stored in the storage unit 230 indicates that the mass production desire is present, a purchase demand of the additional device.

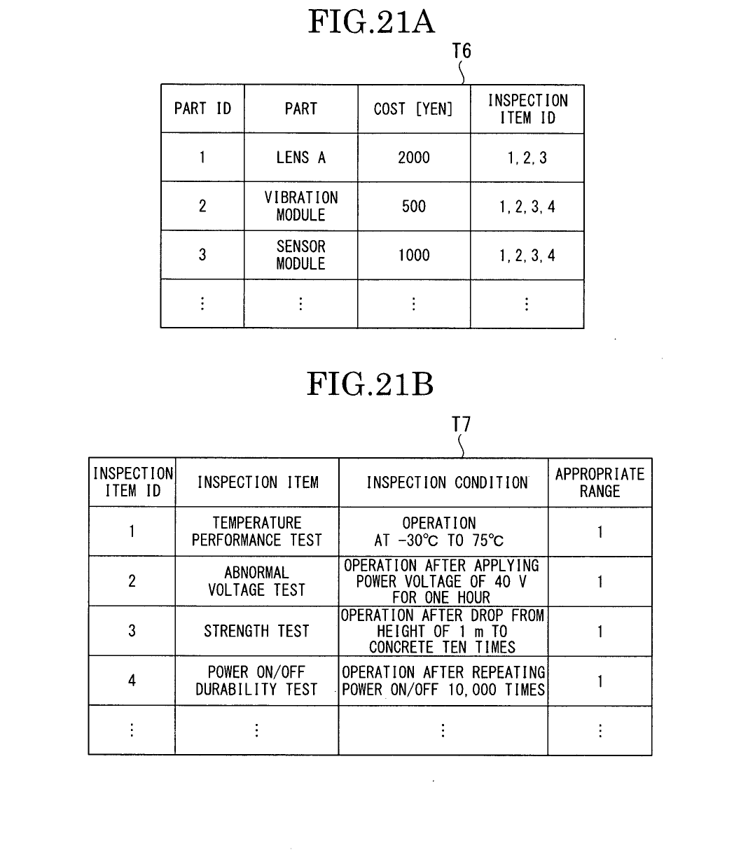

FIG. 21A is a diagram illustrating an example of Table T6 in which the part information stored in the storage unit 210 is written. Here, the part information refers to information about parts that are selectable for the additional device. In the figure, each set of a part ID for identifying a part, a part, a cost and an inspection item ID for identifying an inspection item by which inspection is necessary is shown. It is shown that, for example, if the part ID is 1, the part is “lens A”, the cost is “2,000” yen, and the inspection item IDs for identifying the inspection items by which inspection is necessary are “1, 2 and 3”.

FIG. 21B is a diagram illustrating an example of Table T7 in which the inspection item information stored in the storage unit 210 is written. In the figure, each set of an inspection item ID, an inspection item, an inspection condition and an appropriate range of an inspection result of an inspection item is shown. It is shown that, for example, if the inspection item ID is 1, the inspection item is “temperature performance test”, the inspection condition is “operation at −30° C. to 75° C.”, and the appropriate range of the inspection result is “1”. Here, the inspection result of the temperature performance test is 1 when operated at −30° C. to 75° C., and is 0 when not operated at −30° C. to 75° C.

In FIG. 21A, an inspection item of which the inspection item ID is 1 corresponds to the temperature performance test in Table T7. Further, an inspection item of which the inspection item ID is 2 corresponds to an abnormal voltage test in Table T7. Further, an inspection item of which the inspection item ID is 3 corresponds to a strength test in Table T7. Accordingly, when the part ID is 1, the necessary inspection items are the temperature performance test, the abnormal voltage test and the strength test.

The control unit 230 reads, when the part information of which the check box is checked is input from the manufacturer terminal 300_{—}j through the communication unit 220, the cost corresponding to the part information from the storage unit 210. The control unit 230 transmits the read cost to the manufacturer terminal 300_{—}j through the communication unit 220.

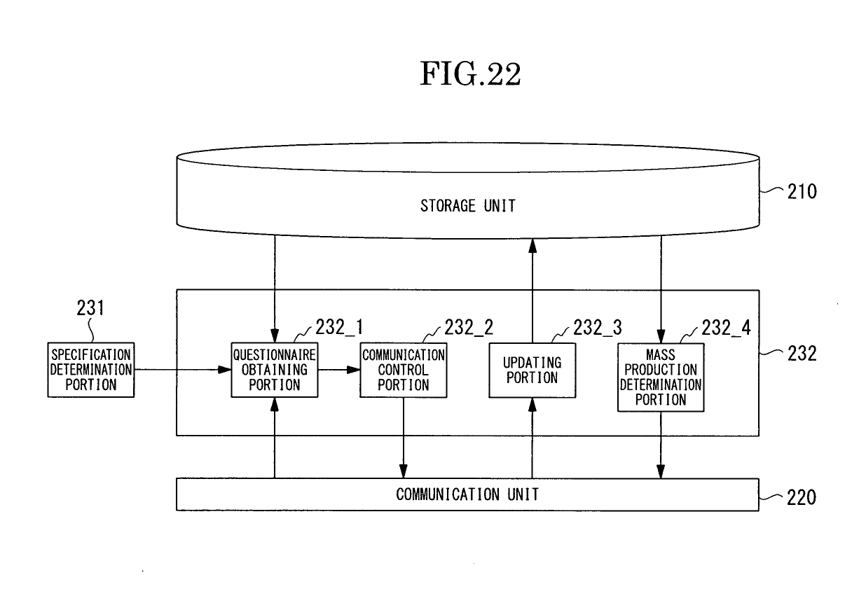

FIG. 22 is a block diagram schematically illustrating a configuration of the purchase information inspection portion 232. The purchase information inspection portion 232 includes a questionnaire obtaining portion 232_1, a communication control portion 232_2, an updating portion 232_3, and a mass production determining portion 234_4.

The questionnaire obtaining portion 232_1 obtains, when the communication unit 220 receives access from a terminal device that includes a user terminal 100_{—}i to which idea information is transmitted, questionnaire answer page information indicating a questionnaire that asks about the presence or absence of a purchase demand of an additional device that realizes the idea, and outputs the obtained questionnaire answer page information to the communication control portion 232_2. Specifically, for example, the questionnaire obtaining portion 232_1 reads the answer page information stored in the storage unit 210 in advance, and outputs the read answer page information to the communication control portion 232_2.

The communication control portion 232_2 transmits the questionnaire answer page information input from the questionnaire obtaining portion 232_1 to the terminal device 100_{—}i that accesses the server apparatus 200 and displays the questionnaire answer page through the communication unit 220.

Whenever receiving the questionnaire answer information from the terminal device 100_{—}i through the communication unit 220, the updating portion 232_3 updates the number of purchase demands stored in the storage unit 210 based on the answer information including purchase desire number information (quantity information).

Whenever the number of purchase demands is updated by the updating portion 232_3, the mass production determining portion 234_4 determines whether or not the number of purchase demands stored in the storage unit 210 exceeds a predetermined threshold value. If the number exceeds the predetermined threshold value, the mass production determining portion 234_4 determines the mass production of the additional device. Further, the mass production determining portion 234_4 sets the mass production flag associated with the additional device ID of the additional device of which the mass production is determined to 1, in Table T5 of the storage unit 210.

Further, the mass production determining portion 234_4 makes reference to an idea ID associated with the additional device ID in Table T5 of the storage unit 210. Further, the mass production determining portion 234_4 extracts a user address associated with the user ID in Table T1 of the storage unit 210, with reference to the user ID associated with the idea ID in Table T3 of the storage unit 210. Further, the mass production determining portion 234_4 transmits a mail indicating that the additional device is to be mass-produced to the extracted mail address through the communication unit 220.

Returning to FIG. 17, when the sale page request of the additional device transmitted from the user terminal 100_{—}i is input through the communication unit 220, the sale processing portion 234 reads a variety of information of the additional device from Table T5 of the storage unit 210. Further, the sale processing portion 234 reads the source code of the sale page from the storage unit 210. Further, the sale processing portion 234 inserts the variety of read information of the additional device in a predetermined place of the source code of the sale page. Further, the sale processing portion 234 transmits sale page information indicating the source code of the sale page changed by the insertion to the user terminal 100_{—}i that made the sale page request of the additional device through the communication unit 220.

Further, the sale processing portion 234 extracts, when purchased additional device ID information transmitted from the user terminal 100_{—}i is input through the communication unit 220, the user ID that contributes to the idea of the additional device from the storage unit 210. Here, the purchased additional device ID refers to an additional device ID of which the purchase is ordered by a user.

Specifically, the sale processing portion 234 makes reference to the idea ID corresponding to the input purchased additional device ID in Table T5 of the storage unit 210. Further, the sale processing portion 234 reads the user ID associated with the referenced idea ID in Table T3 of the storage unit 210. Thus, the sale processing portion 234 can extract the user ID who contributes to the idea of the additional device of the purchased additional device ID.

The sale processing portion 234 reads a deposit bank account associated with the extracted user ID in Table T1 of FIG. 15. Further, the sale processing portion 234 reads a mail address of which the manufacturer category is the management enterprise in Table T2 of FIG. 15. Further, the sale processing portion 234 transmits a mail indicating that an idea royalty is to be remitted to a deposit bank account of a user who contributes to an idea to the mail address of the read management enterprise. Thus, the management enterprise can confirm the content of the mail, and can remit the idea royalty to the deposit bank account of the user who contributes to the idea.

Further, the manufacturer terminal 300_{—}j transmits delivery arrangement completion information indicating that delivery of an ordered additional device is arranged to the manufacturer terminal 300_{—}j. The sale processing portion 234 reads, when the delivery arrangement completion information transmitted from the manufacturer terminal 300_{—}j is input through the communication unit 220, a mail address associated with a user ID of a user who desires the purchase from Table T1 of the storage unit 210.

Further, the sale processing portion 234 transmits a mail indicating that the delivery is arranged to the read mail address through the communication unit 220. Thus, the sale processing portion 234 can transmit the mail indicating that the delivery is arranged to the mail address of the user who made the order through the communication unit 220.

Subsequently, a process of the authentication portion 235 will be described. The authentication portion 235 reads, when the authentication page request transmitted from the manufacturer terminal 300_{—}j is input through the communication unit 220, authentication page information indicating the source code of the authentication page from the storage unit 210. Further, the authentication portion 235 transmits the read authentication page information to the manufacturer terminal 300_{—}j through the communication unit 220. Thus, the manufacturer terminal 300_{—}j can display the authentication page.

When the additional device ID, the inspection item information indicating the inspection item of the additional device of the additional device ID and the inspection result information indicating the inspection result for each inspection item transmitted from the manufacturer terminal 300_{—}j are input through the communication unit 220, the authentication portion 235 determines whether or not the value of the inspection result indicated by the inspection result information is in a predetermined appropriate range. Further, when plural inspection items are present, the authentication portion 235 determines whether or not the inspection results of all inspection items are in the predetermined appropriate range for each inspection item.

Specifically, for example, the authentication portion 235 performs the following process for each inspection item. The authentication portion 235 reads the appropriate range associated with the inspection item indicated by the inspection item information input through the communication unit 220 from Table T7 of the storage unit. Further, the authentication portion 235 determines whether or not the inspection result input through the communication unit 220 is in the read appropriate range.

When the inspection results of all the inspection items are in the predetermined appropriate range for each inspection item, the authentication portion 235 determines that the additional device of the additional device ID is authenticated. Further, the authentication portion 235 sets the authentication flag associated with the additional device ID of the additional device to 1 in Table T5 of the storage unit 210.

On the other hand, when any inspection result of the inspection items is not in the predetermined appropriate range for any inspection item, the authentication portion 235 determines that the additional device of the additional device ID is not authenticated. Further, the authentication portion 235 sets the authentication flag associated with the additional device ID of the additional device to 0 in Table T5 of the storage unit 210.

Further, the authentication portion 235 transmits, after updating the authentication flag in Table T5 of the storage unit 210, authentication result information indicating the authentication result of the additional device to the manufacturer terminal 300_{—}j through the communication unit 220. Thus, the manufacturer terminal 300_{—}j can display the authentication result of the additional device, and thus, the manufacturer who operates the manufacturer terminal 300_{—}j can recognize the authentication result of the additional device.

Subsequently, a process of the patentability determination portion 236 will be described. When the idea information indicating the idea of the additional device or the specification information indicating the specification of the additional device transmitted from the user terminal 100_{—}i is input through the communication unit 220, the patentability determination portion 236 generates an idea ID, and additionally writes the generated idea ID and the idea information or the specification information in Table T3 of the storage unit 210. Further, the patentability determination portion 236 extracts a search word for searching related art documents based on the idea indicated by the idea information or the specification indicated by the specification information.

Specifically, for example, when the idea is “camera capable of imaging when an object is stationary”, the patentability determination portion 236 extracts “object”, “stationary”, “imaging” and “camera”. Further, the patentability determination portion 236 reads a synonym of each extracted word from the storage unit 210, and sets each word and the synonym as the search words. For example, the patentability determination portion 236 reads “stopped” that is a synonym of “stationary”, and “imaging device” that is a synonym of “camera”. Further, the patentability determination portion 236 sets “object”, “stationary” or “stopped”, “imaging” and “camera” or “imaging device” as the search words.

The related art document information indicating the content of the related art documents is stored in the storage unit 210 in advance.

Further, the patentability determination portion 236 makes reference to the related art documents stored in the storage unit 210, and determines whether or not a set of the extracted search words is present in the related art documents. Specifically, for example, the patentability determination portion 236 determines whether or not there is a related art patent document (for example, a published unexamined patent application) in which all the extracted search words are included in the whole publication.

When the set of the extracted search words is not present in the related art patent documents, the patentability determination portion 236 determines that novelty is present in the original idea or original configuration from which the search words are extracted. Further, the patentability determination portion 236 sets the novelty flag associated with the idea ID to 1 in Table T3 of the storage unit 210.

If the set of the extracted search words is present in the related art patent documents, the patentability determination portion 236 determines that novelty is not present in the original idea or original configuration from which the search words are extracted. Further, the patentability determination portion 236 sets the novelty flag associated with the idea ID to 0 in Table T3 of the storage unit 210.

In the present embodiment, the patentability determination portion 236 searches the storage unit 210 of the apparatus, but the invention is not limited thereto. The patentability determination portion 236 can search an external database.

When the manufacturer ID and the right transfer proposal page request transmitted from the manufacturer terminal 300_{—}j are input through the communication unit 220, the patentability determination portion 236 makes reference to Table T2 of the storage unit 210, and determines whether or not the manufacturer category of the input manufacturer ID is the management enterprise. When the manufacturer category is not the management enterprise, the patentability determination portion 236 transmits information indicating that the manufacturer who requests the right transfer proposal page (for example, shown in FIG. 13) is not the management enterprise to the manufacturer terminal 300_{—}j through the communication unit 220.

Thus, the manufacturer terminal 300_{—}j displays the information indicating that the manufacturer who requests the right transfer proposal page is not the management enterprise. That is, the manufacturer of which the manufacturer category is not the management enterprise is not allowed to browse the right transfer proposal page. Thus, the patentability determination portion 236 can prevent proposal of the right transfer to the user from the manufacturer of which the manufacturer category is not the management enterprise. Further, the patentability determination portion 236 does not allow the manufacturer of which the manufacturer category is not the management enterprise to browse the idea that is not open to the public and is newly contributed, thereby making it possible to prevent the idea from being publicly known. Here, it is assumed that when the user makes a user registration, the user and the manufacturer that is the management enterprise conclude a confidentiality agreement that both the parties shall not disclose or leak the contributed idea to a third party.

On the other hand, when the manufacturer category is the manufacturer enterprise, the patentability determination portion 236 reads the source code of the right transfer proposal page from the storage unit 210. Further, the patentability determination portion 236 reads the idea information of which the novelty flag is 1 from Table T3 of the storage unit 210. Further, the patentability determination portion 236 reads the specification information of which the novelty flag is 1 from Table T5 of the storage unit 210. Further, the patentability determination portion 236 inserts the idea indicated by the read idea information and the specification indicated by the specification information in predetermined places of the source code of the right transfer proposal pages. Thus, the patentability determination portion 236 can generate the right transfer proposal page information to be displayed in the browser screen.

The patentability determination portion 236 transmits the right transfer proposal page information indicating the source code of the right transfer proposal page changed by the insertion to the manufacturer terminal 300_{—}j that requests the right transfer proposal page through the communication unit 220. Thus, the manufacturer terminal 300_{—}j can display the right transfer proposal page (for example, shown in FIG. 13).

When the idea ID and the right transfer request information for requesting transfer of the patentable right for the idea of the idea ID transmitted from the manufacturer terminal 300_{—}j are input through the communication unit 220, the patentability determination portion 236 makes reference to the user ID associated with the input idea ID in Table T3 of the storage unit 210, and reads mail address information associated with the referenced user ID in Table T1 of the storage unit 210. Further, the patentability determination portion 236 transmits a mail for requesting the transfer of the patentable right for the idea to the mail address indicated by the read mail address information.

When the idea ID and transfer consent information indicating a consent to the transfer of the patentable right for the idea of the idea ID transmitted from the user terminal 100_{—}i are input through the communication unit 220, the patentability determination portion 236 changes a transfer consent flag associated with the idea ID to 1 in Table T3 of the storage unit 210. Further, the patentability determination portion 236 transmits a message indicating that the idea royalty is to be remitted to a deposit bank account of an idea contributor to the user terminal 100_{—}i that transmits the transfer consent information through the communication unit 220. Thus, the user terminal 100_{—}i that transmits the transfer consent information can display the message indicating that the idea royalty is to be remitted to the deposit bank account of the idea contributor.

Subsequently, a process of the improved idea determination portion 237 will be described. When an idea ID and a request for an improved idea input page for inputting an improved idea for the idea of the idea ID transmitted from the user terminal 100_{—}i are input through the communication unit 220, the improved idea determination portion 237 reads the source code of the improved idea input page from the storage unit 210. Further, the improved idea determination portion 237 reads the idea information associated with the idea ID from Table T3 of the storage unit 210, and inserts the idea indicated by the read idea information in a predetermined place of the source code of the improved idea input page. Thus, the improved idea determination portion 237 can include a basic idea that is an improvement target in a predetermined place of the improved idea input page.

Further, the improved idea determination portion 237 transmits the improved idea input page information indicating the source code of the improved idea input page changed by the insertion to the user terminal 100_{—}i that requests the improved idea page through the communication unit 220. Thus, the user terminal 100_{—}i that requests the improved idea input page can display the improved idea input page (for example, shown in FIG. 8) including the basic idea that is the improvement target.

When an improved idea contributor user ID, improved idea information indicating the improved idea and a basic idea ID for identifying the basic idea that is the improvement target transmitted from the user terminal 100_{—}i are input through the communication unit 220, the improved idea determination portion 237 generates an idea ID for identifying the improved idea. Here, the improved idea contributor user ID refers to a user ID that contributes the improved idea. Further, the improved idea determination portion 237 additionally writes the generated idea ID in association with the input improved idea contributor user ID, basic idea ID and improved idea information in Table T3 of the storage unit 210.

Specifically, for example, in the example of an area 191 in Table T3 of FIG. 18, the improved idea determination portion 237 associates and stores an idea ID “4”, a user ID “3”, a basic idea “1”, an idea “camera capable of imaging when an object is stationary and when an object faces the front”, the presence or absence of a mass production desire “present”, and a specification creation time limit “Apr. 30, 2011”.

Thus, when the polling page request transmitted from the user terminal 100_{—}i is input through the communication unit 220, the improved idea determination portion 237 reads the source code of the polling page from the storage unit 210. Further, the improved idea determination portion 237 reads information indicating idea IDs, ideas and polling scores of all ideas including the additionally written improved idea from Table T3 of the storage unit 210. Further, the improved idea determination portion 237 inserts the idea IDs, the ideas, and the polling scores in the source code of the polling page so that the idea IDs, the ideas and the polling scores are arranged in the descending order of the polling score so that the ranking is high when the polling score is high. Thus, the improved idea determination portion 237 can generate the source code of the polling page indicating the browser screen (for example, W60 shown in FIG. 6) of the polling page.

Further, the improved idea determination portion 237 transmits the polling page information indicating the source code of the polling page changed by the insertion to the terminal device 100_{—}i that requests the polling page through the communication unit 220. Thus, the terminal device 100_{—}i can display the browser screen (for example, W60 shown in FIG. 6) of the polling page, and the user can vote for the improved idea.

Further, the improved idea determination portion 237 accepts votes for the improved idea, similarly to the basic idea. Specifically, the improved idea determination portion 237 increases, when the idea ID of the improved idea voted for by the user through the polling page is input from the user terminal 100_{—}i through the communication unit 220, the polling score associated with the idea ID of the improved idea by 1 in Table T3 of the storage unit 210. Thus, if there is an access to the polling page later, the improved idea determination portion 237 reads the updated polling score and inserts the read polling score in the polling page, thereby making it possible to update the polling score in the polling page.

When the polling score of the improved idea exceeds a predetermined threshold value due to the updating of the polling score in Table T3 of the storage unit 210, the improved idea determination portion 237 determines employment of the improved idea. Further, the improved idea determination portion 237 makes reference to Table T3 of the storage unit 210, to thereby calculate the number of base ideas indicating how many base ideas are improved by the improved idea. Further, the improved idea determination portion 237 divides a predetermined idea royalty by a number obtained by adding 1 to the number of base ideas, to thereby calculate an idea royalty per person.

The calculation of the idea royalty per person in the improved idea determination portion 237 of the present embodiment is performed based on the predetermined idea royalty, but the idea royalty may increase as the polling score becomes higher. Thus, since the improved idea determination portion 237 increases the idea royalty as the polling score becomes higher, it is possible to motivate the user to contribute an excellent idea.

Further, the improved idea determination portion 237 may determine the idea royalty based on the user category of the user with reference to Table T1 of the storage unit 210. Specifically, since the category of the user is changed according to the number of ideas realized by the additional devices, the improved idea determination portion 237 may increase the idea royalty as the user category is changed from the light user to the middle user and the heavy user. In other words, if the user category is considered as the user ranking, the improved idea determination portion 237 may increase the idea royalty as the user ranking increases. Here, the user rankings arranged in the descending order are the heavy user, the middle user and the light user.

Thus, since the ranking of the user whose ideas are realized more in the additional devices increases, the improved idea determination portion 237 can motivate the user to contribute more excellent ideas.

Further, the improved idea determination portion 237 may increase the idea royalty as the number of ideas realized in the additional devices up to now becomes larger, with reference to Table T1 of the storage unit 210. Thus, since the improved idea determination portion 237 increases the idea royalty as the number of ideas realized in the additional devices becomes larger, it is possible to motivate the user to contribute to more excellent ideas.

Further, the improved idea determination portion 237 makes reference to the user ID associated with the idea ID of the base idea in Table T3 of the storage unit 210, and reads information indicating a mail address of the user who contributes the base idea associated with the referenced user ID in Table T1 of the storage unit 210. Further, the improved idea determination portion 237 transmits a mail indicating that the employment of the improved idea is determined and the idea royalty is to be remitted to the deposit bank account to the mail address indicated by the read information.

Similarly, the improved idea determination portion 237 makes reference to the user ID associated with the idea ID of the improved idea in Table T3 of the storage unit 210, and reads information indicating a mail address of the user who contributes the improved idea associated with the referenced user ID in Table T1 of the storage unit 210. Further, the improved idea determination portion 237 transmits a mail indicating that the employment of the improved idea is determined and the idea royalty is to be remitted to the deposit bank account to the mail address indicated by the read information.

The improved idea determination portion 237 outputs the idea ID of the improved idea and a message indicating that the employment of the improved idea is determined to the manufacturing determination portion 232. In this case, when the idea ID of the improved idea and the message indicating that the employment of the improved idea is determined are input, the manufacturing determination portion 232 determines a manufacturer who realizes the improved idea, and thus, it is similarly possible to realize the improved idea in the additional device.

Subsequently, a process of the inspection item extraction portion 238 will be described. The inspection item extraction portion 238 makes reference to a part associated with the additional device ID in the storage unit 210 when the additional device ID is input from the manufacturer terminal 300_{—}j through the communication unit 220. Further, the inspection item extraction portion 238 extracts an inspection item associated with the referenced part.

Specifically, for example, when the additional device ID of 2 is input from the manufacturer terminal 300_{—}j, the inspection item extraction portion 238 makes reference to the vibration module that is the part when the additional device ID is 2, in Table T5 (FIG. 20) of the storage unit 210. Further, in Table T6 (FIG. 21A) of the storage unit 210, the inspection item extraction portion 238 makes reference to “1, 2, 3 and 4” that are inspection item IDs by which the inspection is necessary corresponding to the referenced vibration module, and reads inspection items (specifically, temperature performance test, abnormal voltage test, strength test and power ON/OFF durability test) and inspection conditions corresponding to the referenced inspection item IDs.

The inspection item extraction portion 238 reads the source code of the inspection item input page from the storage unit 210, and inserts the read inspection items and inspection conditions in the source code of the read inspection item input page. Thus, the inspection item extraction portion 238 can generate the source code of the inspection item input page as shown in FIG. 12. The inspection item extraction portion 238 transmits the generated source code of the inspection item input page to the manufacturer terminal 300_{—}j through the communication unit 220.

Thus, when the additional device ID is input in the input section R121 of the inspection item input page shown in FIG. 12, the inspection item extraction portion 238 transmits the source code of the inspection item input page in which the inspection items and inspection conditions based on the additional device ID are inserted to the manufacturer terminal 300_{—}j.

Further, the manufacturer terminal 300_{—}j displays the inspection item input page based on the source code of the inspection item input page received from the server apparatus 200. Thus, the manufacturer terminal 300_{—}j can display the inspection items and inspection conditions based on the additional device ID in the inspection item input page. Thus, the manufacturer of the additional device that operates the manufacturer terminal 300_{—}j can reduce an effort of the manufacturer of the additional device without necessity for checking the inspection items to be input and the inspection conditions corresponding to the inspection items for oneself, and therefore, can smoothly input the inspection results corresponding to the inspection items into the system.

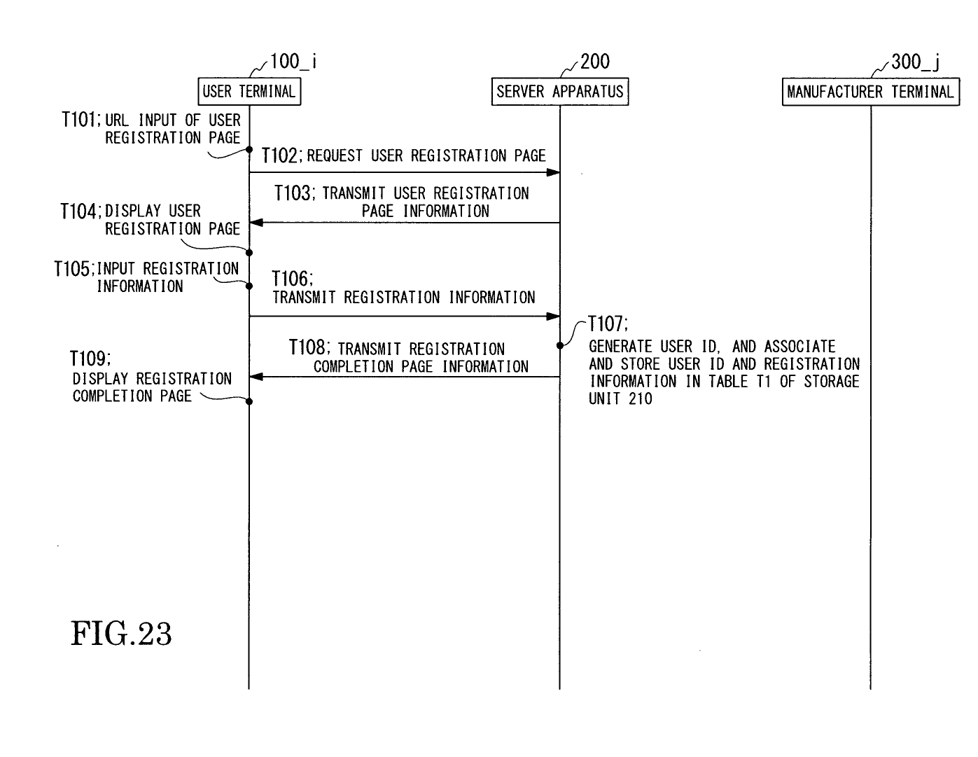

FIG. 23 illustrates an example of a sequence diagram illustrating the flow of a user registration process. First, the user terminal 100_{—}i receives a URL input of a user registration page (T101). Then, the user terminal 100_{—}i requests the user registration page (T102) from the server apparatus 200. Then, the server apparatus 200 transmits user registration page information to the user terminal 100_{—}i that requests the user registration page (T103). Then, the user terminal 100_{—}i receives the user registration page information from the server apparatus 200, and displays the user registration page (T104).

Then, the user terminal 100_{—}i receives an input of registration information in the user registration page (T105). Then, the user terminal 100_{—}i transmits the received registration information to the server apparatus 200 (T106). Then, when receiving the registration information, the server apparatus 200 generates a user ID, and associates and stores the user ID and the registration information in Table T1 of the storage unit 210 (T107). Then, the server apparatus 200 transmits registration completion page information indicating a source code of a registration completion page to the user terminal 100_{—}i that transmits the registration information (T108). Then, the user terminal 100_{—}i displays the registration completion page (T109). Hence, the process of the present sequence is terminated.

As described above, the server apparatus 200 of the present embodiment stores registration information of a new user in the storage unit 210 in association with a user ID. Thus, the server apparatus 200 can manage the registration information of the user.

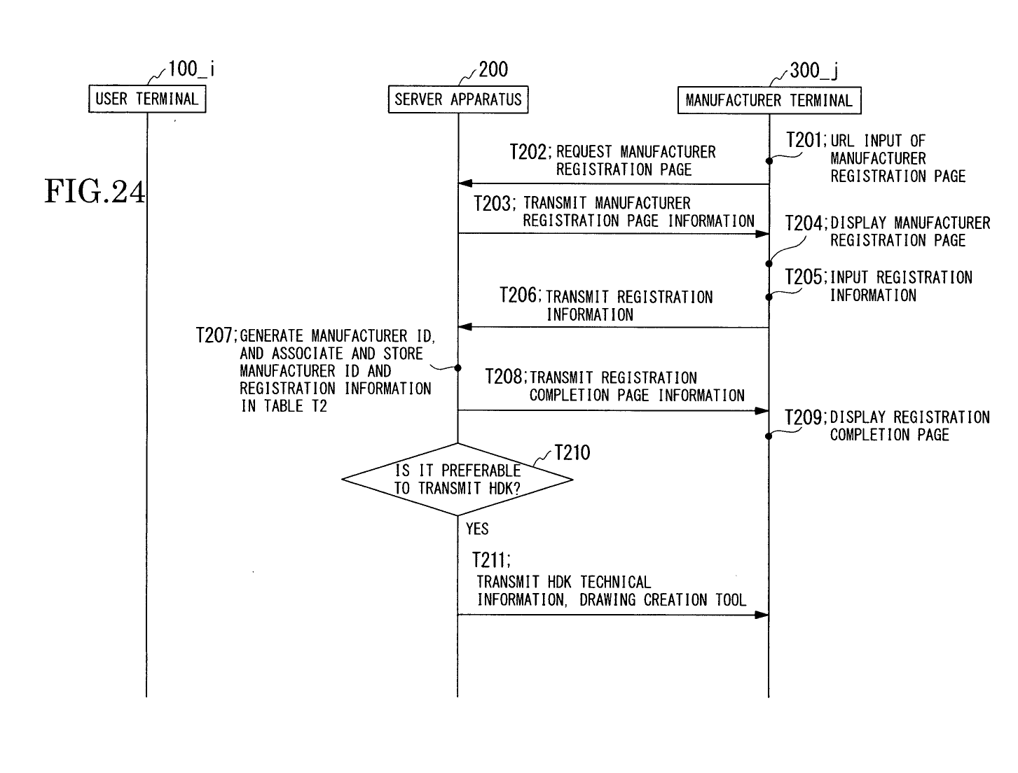

FIG. 24 illustrates an example of a sequence diagram illustrating the flow of a manufacturer registration process. First, the manufacturer terminal 300_{—}j receives a URL input of a manufacturer registration page (T201). Then, the manufacturer terminal 300_{—}j requests the manufacturer registration page from the server apparatus 200 (T202). Then, the server apparatus 200 transmits the manufacturer registration page information to the manufacturer terminal 300_{—}j that requests the manufacturer registration page (T203). Then, the manufacturer terminal 300_{—}j receives the manufacturer registration page information from the server apparatus 200, and displays the manufacturer registration page (T204).

Then, the manufacturer terminal 300_{—}j receives an input of registration information in the manufacturer registration page (T205). Then, the manufacturer terminal 300_{—}j transmits the received registration information to the server apparatus 200 (T206). Then, when receiving the registration information from the manufacturer terminal 300_{—}j, the server apparatus 200 generates a manufacturer ID, and associates and stores the manufacturer ID and the registration information in Table T2 of the storage unit 210 (T207). Then, the server apparatus 200 transmits registration completion page information indicating a source code of a registration completion page to the manufacturer terminal 300_{—}j that transmits the registration information (T208). Then, the manufacturer terminal 300_{—}j displays the registration completion page (T209).

Then, the server apparatus 200 determines whether or not it is preferable to transmit the HDK based on the registration information stored in the storage unit 210 (T210). If it is determined that it is preferable to transmit the HDK technical information, the server apparatus 210 transmits information indicating the HDK technical information and a drawing creation tool, respectively, to the manufacturer terminal 300_{—}j (T211). Hence, the process of the present sequence is terminated.

As described above, the server apparatus 200 of the present embodiment stores registration information of a new manufacturer in the storage unit 210 in association with a manufacturer ID. Thus, the server apparatus 200 can manage the registration information of the manufacturer. Further, the server apparatus 200 determines whether or not it is preferable to transmit the HDK technical information based on the registration information. Thus, the server apparatus 200 can exclude a dishonest manufacturer.

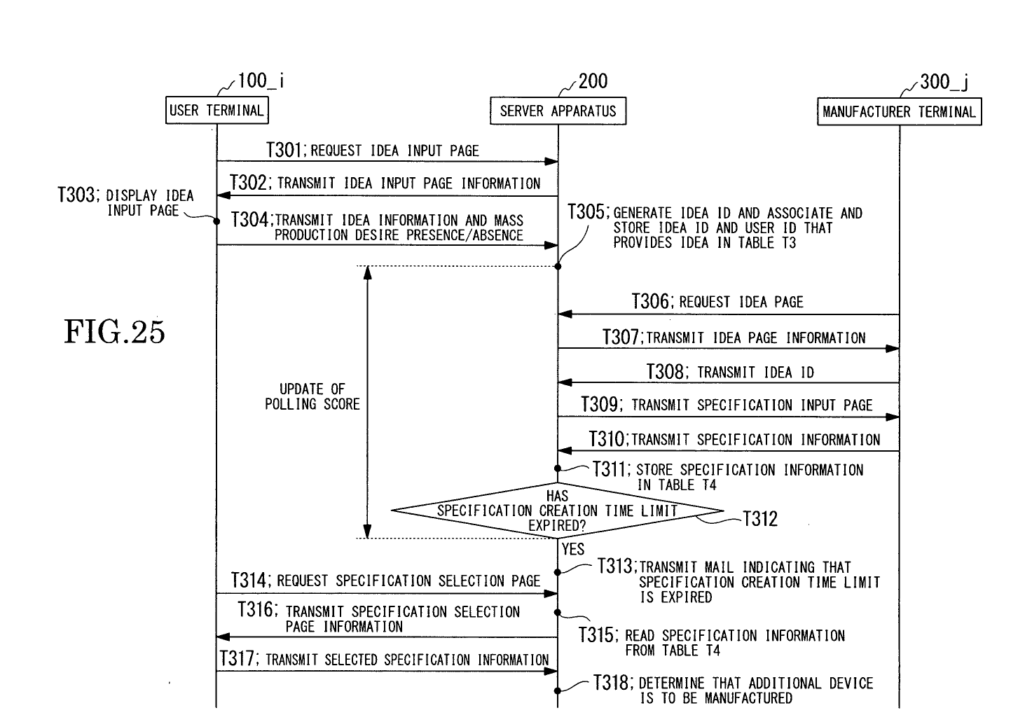

FIG. 25 illustrates an example of a sequence diagram illustrating the flow of a manufacturing determination process. First, the user terminal 100_{—}i requests an idea input page from the server apparatus 200 (T301). Then, the server apparatus 200 transmits idea input page information to the user terminal 100_{—}i that requests the idea input page (T302). Then, the user terminal 100_{—}i displays the idea input page (T303). Then, the user terminal 100_{—}i transmits the idea information received in the idea input page and mass production desire presence/absence information to the server apparatus 200 (T304).

Then, the server apparatus 200 generates an idea ID for an idea indicated by the idea information received from the user terminal 100_{—}i, and associates and stores the generated idea ID and a user ID that provides the idea in Table T3 of the storage unit 210 (T305). Then, the manufacturer terminal 300_{—}j requests an idea list page from the server apparatus 200 (T306). Then, the server apparatus 200 transmits the idea list page information to the manufacturer terminal 300_{—}j that requests the idea list page (T307).

Then, the manufacturer terminal 300_{—}j transmits an idea ID of an idea that is a manufacturing desire target of a manufacturer in the idea list page to the server apparatus 200 (T308). Then, the server apparatus 200 transmits specification input page information on the received idea ID to the manufacturer terminal 300_{—}j that transmits the idea ID (T309). Then, the manufacturer terminal 300_{—}j transmits specification information received in the specification input page to the server apparatus 200 (T310).

Then, the server apparatus 200 generates a specification ID for a specification indicated by the specification information received from the manufacturer terminal 300_{—}j, and associates and stores the generated specification ID and the specification information in Table T4 of the storage unit 210 (T311). Then, the server apparatus 200 determines whether or not a specification creation time limit for a certain idea is expired (T312). If the specification creation time limit is expired, the server apparatus 200 transmits a mail indicating that the specification creation time limit is expired to a mail address of a user who contributes the idea (T313).

Then, according to operation of the user who receives the mail indicating that the specification creation time limit is expired, the user terminal 100_{—}i requests a specification selection page from the server apparatus 200 (T314). Then, the server apparatus 200 reads the specification information from Table T4 in the storage unit 210 (T315). Further, the server apparatus 200 reads a source code of the specification selection page, and inserts the specification in a corresponding position of the source code. Then, the server apparatus 200 transmits specification select page information indicating the source code changed by the insertion to the user terminal 100_{—}i that requests the specification selection page (T316).

Then, the user terminal 100_{—}i displays a specification creator name, an appearance drawing, a part list, a specification and a price in the specification selection page. Then, the user terminal 100_{—}i transmits specification information indicating one specification selected by the user from the displayed specifications in the specification selection page to the server apparatus 200 (T317). Then, the server apparatus 200 determines that an additional device is to be manufactured according to the specification indicated by the received specification information (T318). Further, the server apparatus 200 generates an additional device ID, and associates and additionally writes the additional device ID and the specification information in Table T5 of the storage unit 210. Hence, the process of the present sequence is terminated.

As described above, the server apparatus 200 of the present embodiment receives the specification of the additional device that realizes the idea up to the specification creation time limit. Further, when the specification creation time limit is expired, the server apparatus 200 receives the specification selected by the user who contributes the idea from the specifications of the additional device received by the server apparatus up to then from the user terminal 100_{—}i. Thus, the user who contributes the idea can instruct the manufacturing of the additional device that realizes the idea according to the specification selected by the user. Consequently, it is possible to easily realize an additional device intended by the user who contributes the idea.

Further, since the user terminal 100_{—}i displays the specification creator name, the appearance drawing, the part list, the specification and the price in the specification selection page, the user can select the specification in consideration of the specification creator, the appearance, the part list and the price in addition to the specification. Thus, since the user can determine the specification in consideration of the variety of information, it is possible to increase the level of satisfaction of the user.

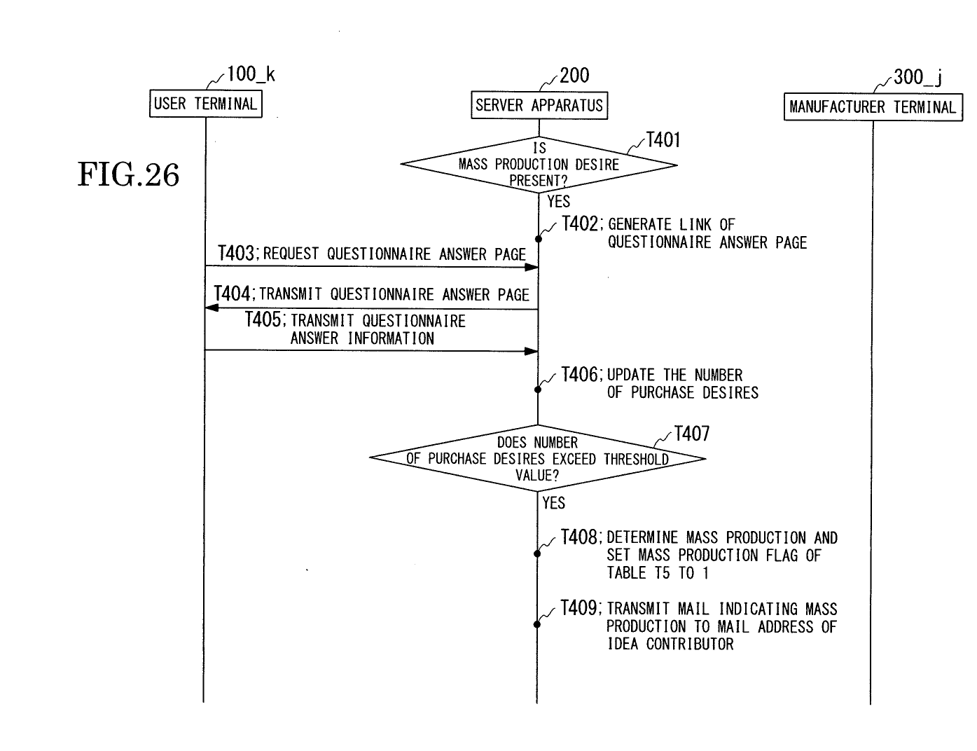

FIG. 26 illustrates an example of a sequence diagram illustrating the flow of a purchase demand research process. First, the server apparatus 200 makes reference to the presence or absence of a mass production desire associated with an idea ID of an idea of which the manufacturing is determined, to thereby determine whether or not the mass production desire is present (T401). When the mass production desire is present, the server apparatus 200 generates a link of a questionnaire answer page that asks for an answer about whether or not to make a purchase when the idea is realized at a price in which the manufacturing is determined (T402).

Then, a user terminal 100_{—}k (k is an integer from 1 to M) requests a questionnaire answer page from the server apparatus 200 (T403). The user terminal 100_{—}k may be the same as the user terminal 100_{—}i.

Then, the server apparatus 200 transmits questionnaire answer page information to the user terminal 100_{—}k that requests the questionnaire answer page (T404). Then, the user terminal 100_{—}k transmits questionnaire answer information received in the questionnaire answer page to the server apparatus 200 (T405).

Then, the server apparatus 200 receives the answer information from the user terminal 100_{—}k and updates the number of purchase desires stored in the storage unit 210 based on the answer information (T406). Then, the server apparatus 200 determines whether or not the number of purchase desires exceeds a threshold value (T407). When the number of purchase desires exceeds the threshold value, the server apparatus 200 determines the mass production of the additional device, and sets the mass production flag associated with the additional device ID of the additional device to 1 in Table T5 of the storage unit 210 (T408). Then, the server apparatus 200 transmits a message indicating the mass production to a mail address of an idea contributor using mail (T409). Hence, the process of the present sequence is terminated.

As described above, the server apparatus 200 of the present embodiment receives, when the user who contributes the idea of which the manufacturing is determined desires the mass production, the answer about whether or not to make a purchase when the idea is realized at the designated price from the user terminal 100_{—}k. Further, the server apparatus 200 determines the mass production when the number of purchase desires exceeds the predetermined threshold value.

Thus, the server apparatus 200 determines mass production of only an additional device that is in demand, and thus, a manufacturer can reduce the risk of having products in stock. Consequently, the server apparatus 200 can motivate the manufacturer to transmit the specification of the additional device that realizes the idea to the server apparatus 200.

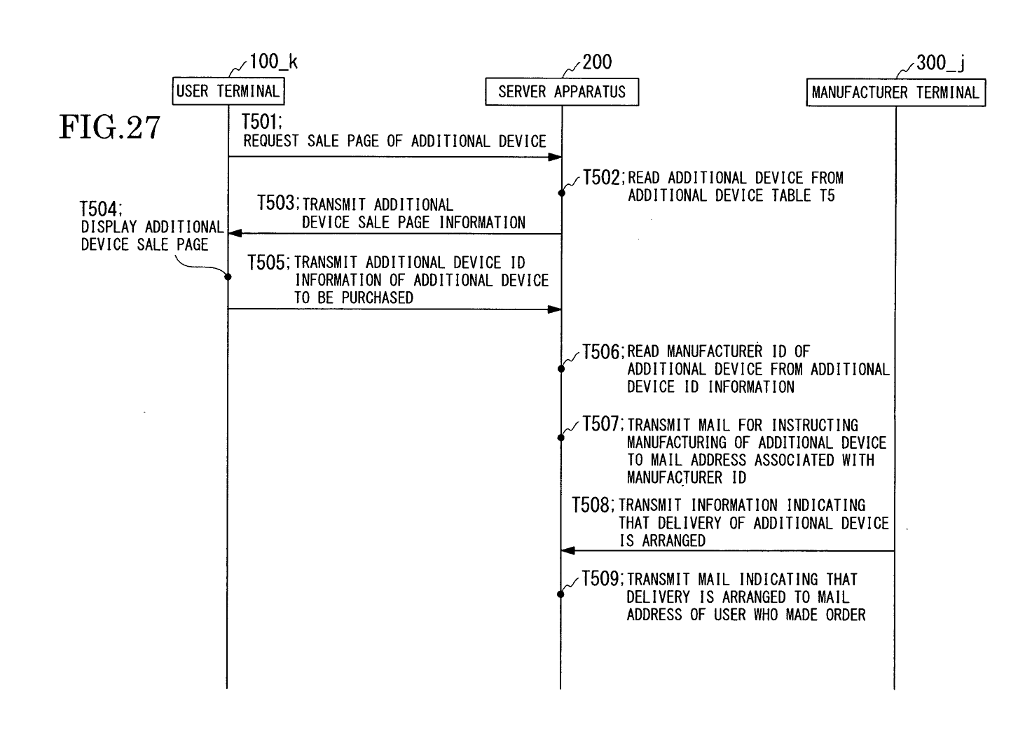

FIG. 27 illustrates an example of a sequence diagram illustrating the flow of a sale process of an additional device of which the mass production is determined.

First, the user terminal 100_{—}k requests a sale page of a certain additional device from the server apparatus 200 (T501). The server apparatus 200 reads a variety of information of the additional device from the storage unit 210 (T502). Then, the server apparatus 200 transmits sale page information including the variety of information of the additional device to the user terminal 100_{—}k that requests the sale page of the additional device (T503). The user terminal 100_{—}k displays the sale page of the additional device indicated by the sale page information received from the server apparatus 200 (T504).

Then, the user terminal 100_{—}k transmits additional device ID information on an additional device to be purchased to the server apparatus 200 (T505). Then, the server apparatus 200 reads a manufacturer ID of a manufacturer of the additional device from the received additional device ID information (T506). Then, the server apparatus 200 transmits a mail for instructing manufacturing of single additional device to a mail address associated with the read manufacturer ID (T507).

Then, the manufacturer terminal 300_{—}j transmits information indicating that delivery of the additional device is arranged to the server apparatus 200 (T508). Then, the server apparatus 200 transmits, when the information indicating that the delivery of the additional device is arranged is received from the manufacturer terminal 300j, a mail indicating that the delivery is arranged to the mail address of the user who made the order (T509). Hence, the process of the present sequence is terminated.

As described above, in the case of the additional device of which the mass production is determined, the server apparatus 200 of the present embodiment receives the order of the additional device from the user terminal 100_{—}k. Further, the server apparatus 200 transmits, when receiving the order of the additional device, the mail for instructing the manufacturing to the manufacturer of the additional device.

Thus, in the case of the additional device of which the mass production is determined, the user can easily order the additional device without negotiation with the manufacturer. Consequently, the user can easily obtain the additional device that realizes a user-desired function with little effort at the time of ordering.

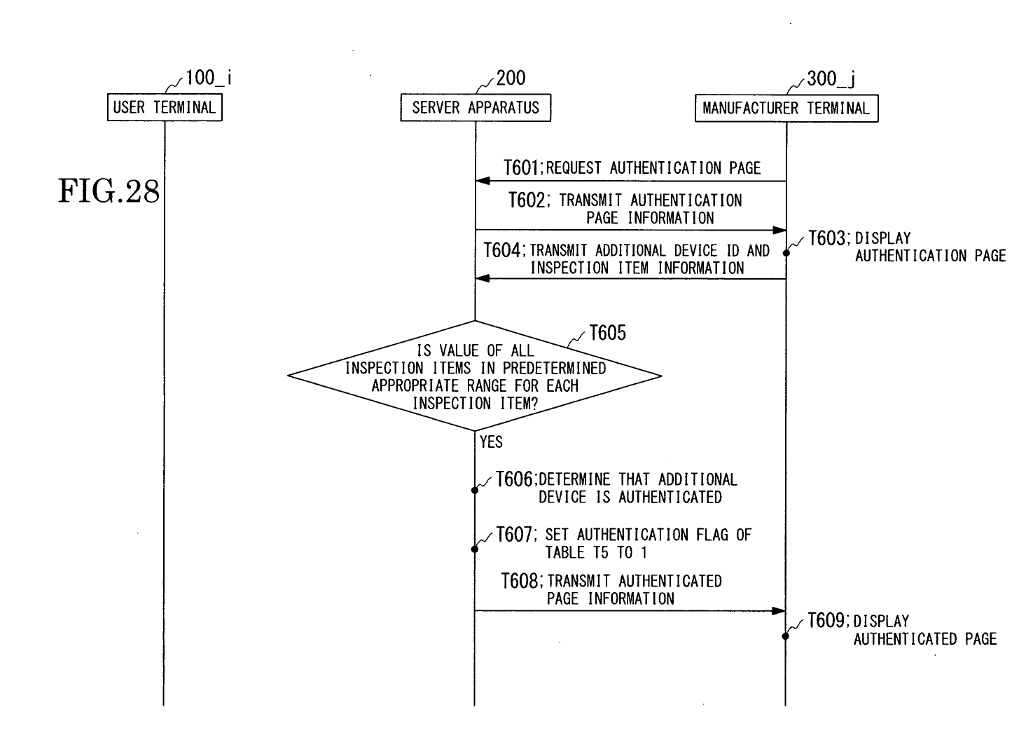

FIG. 28 illustrates an example of a sequence diagram illustrating the flow of an additional device authentication process. First, the manufacturer terminal 300j requests an authentication page from the server apparatus 200 (T601). Then, the server apparatus 200 transmits authentication page information to the manufacturer terminal 300_{—}j that requests the authentication page (T602). The manufacturer terminal 300_{—}j displays the authentication page indicated by the received authentication page information (T603).

Then, the manufacturer terminal 300_{—}j transmits an additional device ID and inspection item information input by a manufacturer in the authentication page to the server apparatus 200 (T604). Then, the server apparatus 200 determines whether or not an inspection result of all inspection items is in a predetermined appropriate range for each inspection item using inspection result information indicating the inspection result for each received inspection item (T605). If a value of all the inspection items is in the predetermined appropriate range for each inspection item, the server apparatus 200 determines that the additional device is authenticated (T606).

Then, the server apparatus 200 sets an authentication flag associated with an additional device ID of the additional device of which the authentication is determined to 1 in Table T5 of the storage unit 210 (T607). Then, the server apparatus 200 transmits authenticated page information indicating that the authentication is achieved to the manufacturer terminal 300_{—}j (T608). Thus, the manufacturer terminal 300_{—}j displays the authenticated page (T609). Hence, the process of the present sequence is terminated.

As described above, the server apparatus 200 of the present embodiment determines whether or not the value of all the inspection items received from the manufacturer terminal 300_{—}j is in the predetermined appropriate range for each inspection item. Further, if the value of all the inspection items is in the predetermined appropriate range for each inspection item, the server apparatus 200 authenticates the additional device. Thus, the server apparatus 200 can display whether or not the additional device is authenticated in the sale page of the additional device. Thus, the user can purchase the authenticated additional device, to thereby make it possible to reduce the risk of purchasing a faulty additional device.

The server apparatus 200 may not receive an additional device that is not authenticated by rejection. Thus, the user can safely purchase the additional device.

In the present embodiment, it is considered that the manufacturer directly inputs the value of each inspection item, but the invention is not limited thereto. For example, a third party (for example, a third party inspection agency) may input the value of each inspection item. Thus, since the inspected value is input to the inspection item by the third party, it is possible to increase reliability of the authentication.

Further, the third party may input information indicating whether or not the additional device is authenticated to the manufacturer terminal 300_{—}j, instead of inputting the inspected value by the third party to the manufacturer terminal 300_{—}j. In this case, the manufacturer terminal 300_{—}j may transmit the authentication information indicating whether or not the additional device is authenticated to the server apparatus 200. Thus, it is not necessary that the server apparatus 200 determine whether or not the additional device is authenticated, and thus, it is possible to reduce the process burden of the server apparatus 200. Further, since the authentication result is input by the third party, it is possible to increase reliability of the authentication.

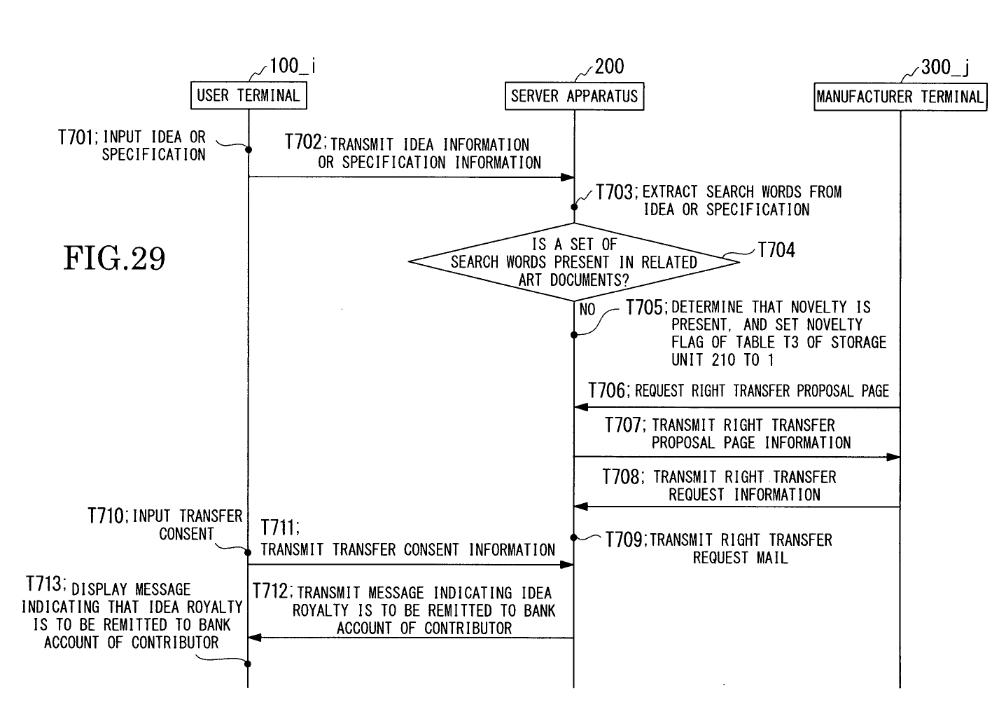

FIG. 29 illustrates an example of a sequence diagram illustrating the flow of a process when novelty is present in an idea or a specification. First, the user terminal 100_{—}i receives an input of an idea or a specification (T701). Then, the user terminal 100_{—}i transmits idea information or specification information to the server apparatus 200 (T702). The server apparatus 200 generates an idea ID, and additionally writes the idea information or the specification information in Table T3 of the storage unit 210. Further, the server apparatus 200 extracts a search word from the idea or the specification (T703). It is determined whether or not a set of the extracted search words is present in related art documents (T704).

If the set of the extracted search words is not present in the related art documents, the server apparatus 200 determines that novelty is present, and sets a novelty flag associated with the idea ID to 1 in Table T3 of the storage unit 210 (T705). The manufacturer terminal 300_{—}j operated by a manufacturer of which the manufacturer category is a management enterprise requests a right transfer proposal page from the server apparatus 200 (T706). The server apparatus 200 transmits right transfer proposal page information to the manufacturer terminal 300_{—}j that requests the right transfer proposal page (T707).

Then, the manufacturer terminal 300_{—}j transmits an idea ID of an idea of which the right transfer is to be requested and which is received in the right transfer proposal page, and right transfer request information to the server apparatus 200 (T708). Then, the server apparatus 200 transmits a right transfer request mail to a mail address of a user who contributes the idea (T709).

Then, the user terminal 100_{—}i receives an input of a transfer consent from the user who contributes the idea (T710). The user terminal 100_{—}i transmits information on the received transfer consent (T711). Then, the server apparatus 200 transmits a message indicating that an idea royalty is to be remitted to a deposit bank account of the contributor to the user terminal 100_{—}i that transmits the transfer consent information (T712). Then, the user terminal 100_{—}i displays the message indicating that the idea royalty is to be remitted to the deposit bank account of the contributor (T713). Hence, the process of the present sequence is terminated.

As described above, the server apparatus 200 of the present embodiment extracts the search words from the idea or the specification. Further, when the set of the extracted search words is not present in the related art documents, the server apparatus 200 sets the novelty flag associated with the idea ID of the idea to 1.

Thus, the management enterprise can determine whether or not to request the transfer of the patentable right only for the idea of which the novelty presence is determined, thereby making it possible to reduce an effort of the management enterprise.

The server apparatus 200 may receive the transfer of the patentable right for the idea with novelty, may complete an invention based on the idea and may file a patent application for the invention before the idea is added to the idea list page, that is, before the idea is open to the public, and thereafter, may display the idea in the idea list page. Thus, it is possible to file the patent application before the idea is open to the public.

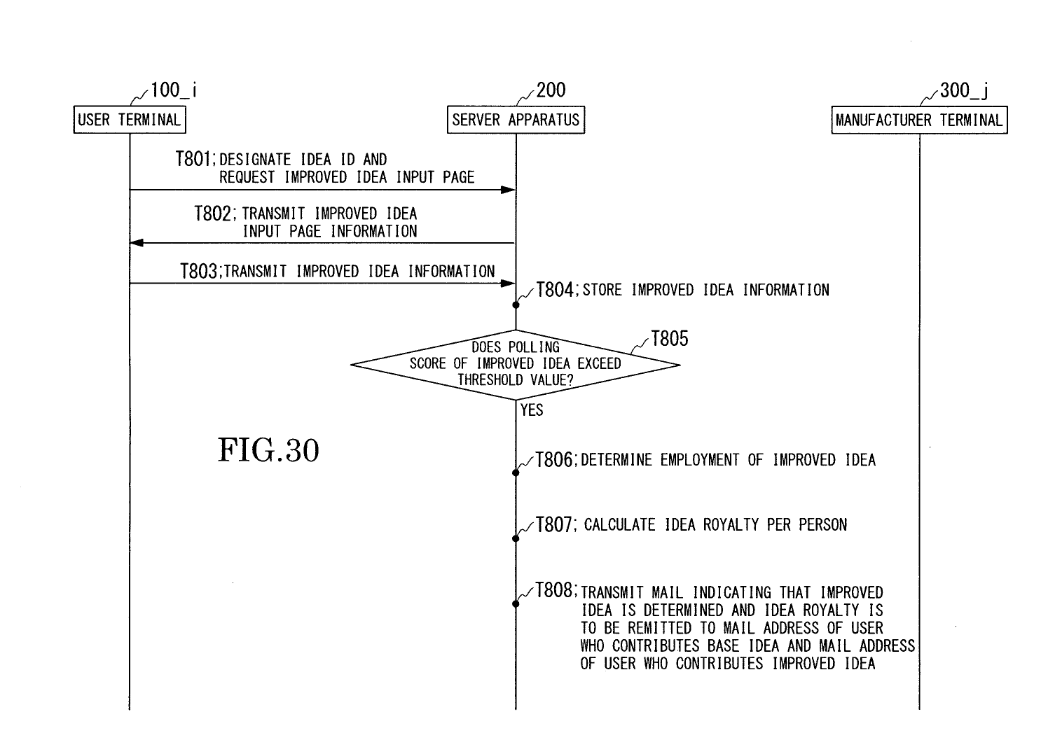

FIG. 30 illustrates an example of a sequence diagram illustrating the flow of an improved idea employing process. First, the user terminal 100_{—}i designates an idea ID for which to request an improved idea input page (T801). The server apparatus 200 transmits improved idea input page information to the user terminal 100_{—}i that requests the improved idea input page (T802). Further, the user terminal 100_{—}i transmits the improved idea information received in the improved idea input page to the server apparatus 200 (T803). Then, the server apparatus 200 additionally writes the improved idea information in Table T3 of the storage unit 210 (T804). Further, the server apparatus 200 determines whether or not a polling score of the improved idea exceeds a predetermined threshold value (T805).

If the polling score of the improved idea exceeds the predetermined threshold value, the server apparatus 200 determines employment of the improved idea (T806). Then, the server apparatus 200 calculates an idea royalty per person (T807). Then, the server apparatus 200 transmits a mail indicating that the employment of the improved idea is determined and the idea royalty is to be remitted to a mail address of a user who contributes a base idea and a mail address of a user who contributes the improved idea (T808). Hence, the process of the present sequence is terminated.

As described above, the server apparatus 200 of the present embodiment determines the employment of the improved idea when the polling score of the improved idea exceeds the predetermined threshold value. Thus, since the server apparatus 200 determines the employment of only the improved idea of which the polling score is high, it is possible to employ only an improved idea that is a target of a high realization desire of a user.

In the present embodiment, the user terminal 100_{—}i and the manufacturer terminal 300_{—}j are used as different terminal devices, but the invention is not limited thereto. The user terminal 100_{—}i and the manufacturer terminal 300_{—}j may be realized as the same terminal device. When both the terminals are realized as the same terminal device, in a login page, a login page of a user and a login page of a manufacturer may be separately provided. Further, the login page may be the same so that ID input sections in which a user ID and a manufacturer ID are input may be the same.

When the login page is the same, the server apparatus 200 may perform a setting so that values of the user ID and the manufacturer ID do not overlap. Thus, the server apparatus 200 can specify the user or manufacturer based on the information input in the ID input section with reference to Table T1 in which the user registration information is stored and Table T2 in which the manufacturer registration information is stored.

### Modification Example

Subsequently, a modification example relating to employment of an improved idea will be described. Idea contribution of a user includes contribution of an original idea and contribution of an improved idea obtained by performing addition or modification for the original idea.

The server apparatus 200 stores the original idea and the improved idea in separate tables in the storage unit 210.

In an original idea table in which the original idea is stored, an original idea ID for identifying the original idea, the content of the original idea and its polling score are associated with each other.

In an improved idea table in which the improved idea is stored, an improved idea ID for identifying the improved idea, the content of the improved idea, its polling score and the original idea ID for identifying the original idea that is a base of the improved idea are associated with each other.

The additional information communication portion 230A transmits, when the communication unit 220 receives improved function information indicating an improved function relating to the function from the user terminal 100_{—}i, the improved function information to the manufacturer terminal 300_{—}j through the communication unit 220.

The specification information communication portion 230B transmits, when the communication unit 220 receives specification information indicating a specification of an additional device for realizing the function or the improved function from the manufacturer terminal 300_{—}j, the specification information to the user terminal 100_{—}i through the communication unit 220.

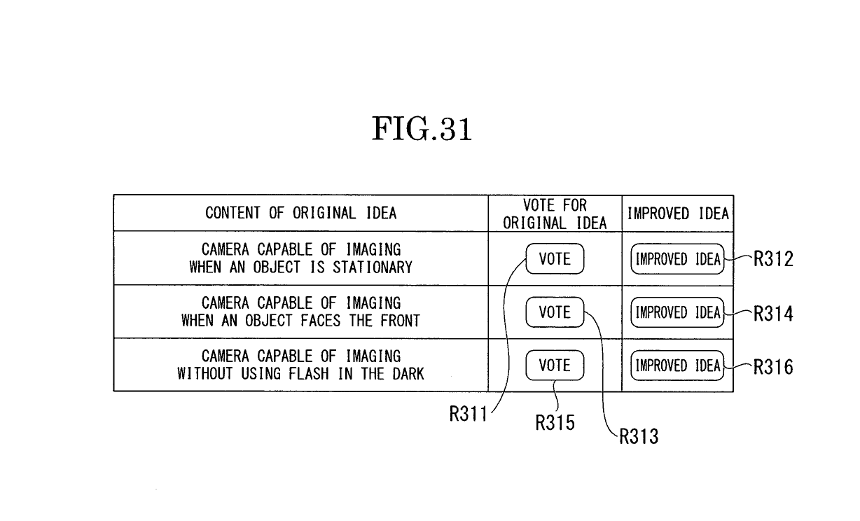

FIG. 31 is a diagram illustrating a display example of an original idea list displayed in the user terminal 100_{—}i. In the figure, a set of content of an original idea, a polling button (R311, R313 or R315) and an improved idea button (R312, R314 or R316) is shown.

In polling of the original idea, if the polling button (R311, 8313 or R315) displayed in the vicinity of the original idea is left-clicked, the user terminal 100_{—}i transmits an ID of the original idea to the server apparatus 200. If the original idea ID is received from the user terminal 100_{—}i, the server apparatus 200 increases the polling score associated with the original idea ID in the storage unit 210 by 1.

If the improved idea button (R312, R314 or R316) is left-clicked, the user terminal 100_{—}i transmits information indicating that the improved idea button is pushed to the server apparatus 200. If the information indicating that the improved idea button is pushed is received from the user terminal 100_{—}i, the server apparatus 200 transmits an improved idea input page in which an improved idea is input to the user terminal 100_{—}i.

Thus, if the improved idea button (R312, R314 or R316) is left-clicked, the user terminal 100_{—}i can display the improved idea input page.

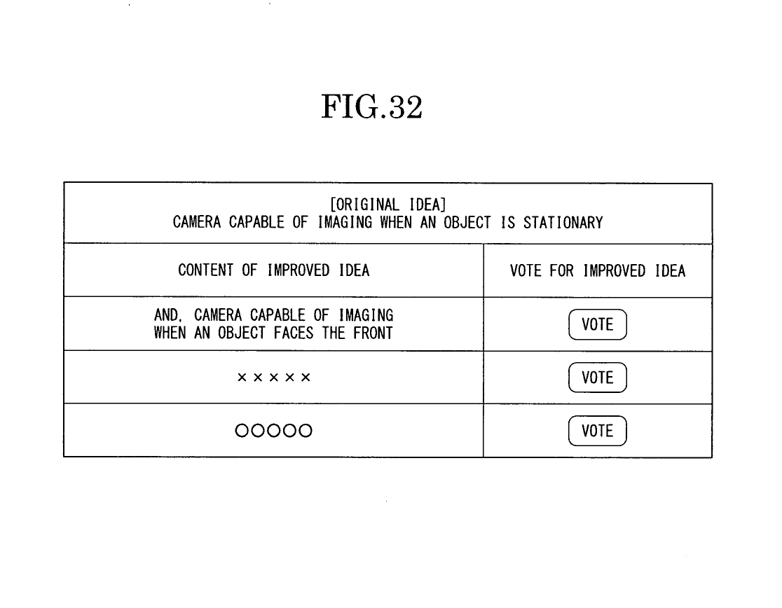

FIG. 32 is a diagram illustrating a display example of an improved idea list displayed in the user terminal 100_{—}i. In the figure, when the original idea is “camera capable of imaging when an object is stationary”, a set of content of an improved idea and a polling button for voting for the improved idea is shown.

If the polling button is left-clicked, the user terminal 100_{—}i transmits an improved idea ID for identifying the improved idea disclosed in the vicinity of the polling button to the server apparatus 200. The server apparatus 200 increases the polling score associated with the improved idea ID received from the user terminal 100_{—}i by 1, in an improved idea table.

The server apparatus 200 makes reference to the original idea ID associated with the received improved idea ID, in the improved idea table. Further, the server apparatus 200 increases the polling score associated with the referenced original idea ID by 1, in the original idea table.

Thus, if voting is performed for the improved idea, the server apparatus 200 can also add the polling score to the original idea that is the base of the improved idea.

The server apparatus 200 limits the number of characters (for example, a full size of 64 characters) for both of the original idea and the improved idea in the idea contribution. Thus, the server apparatus 200 prevents redundant writing and facilitates creation of the addition or modification to the original idea. Further, by limiting the number of characters, the server apparatus 200 can suppress an increase of a storage capacity corresponding to an increase of ideas.

Similarly, the manufacturer terminal 300_{—}j also can request a page of the original idea list (FIG. 31) or a page of the improved idea list (FIG. 32) from the server apparatus 200, to thereby display the original idea list (FIG. 31) or the improved idea list (FIG. 32), respectively.

Thus, the manufacturer can determine employment of the idea and the specification in consideration of both of the original idea list (FIG. 31) and the improved idea list (FIG. 32). Further, the manufacturer can provide a product idea or a specification obtained by combination of plural ideas to the user.

When commercialization is determined by the improved idea, since it is considered that plural inventors are present, the server apparatus 200 may transmit right transfer proposal page information indicating a right transfer proposal page (for example, shown in FIG. 13) for transfer of a patentable right again to the manufacturer terminal 300_{—}j. The manufacturer terminal 300_{—}j can display the right transfer proposal page for the transfer of the patentable right. Thus, the manufacturer who operates the manufacturer terminal 300_{—}j can request the transfer of the patentable right to the plural inventors who invent the improved idea.

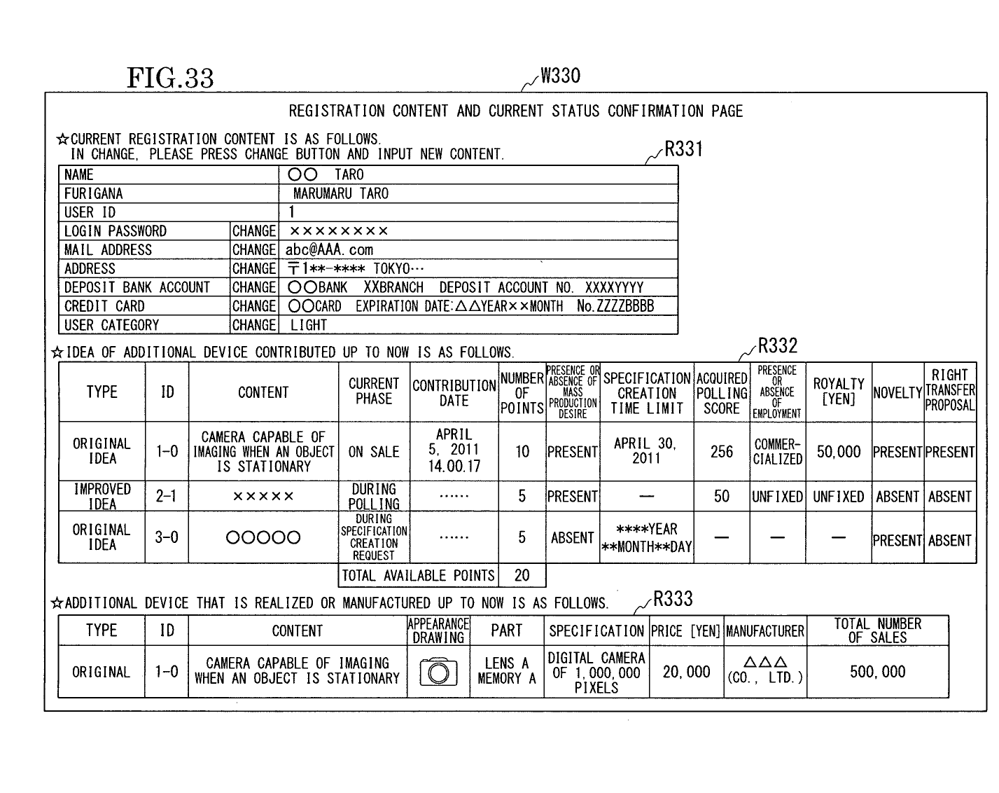

FIG. 33 is a diagram illustrating an example of a browser screen of a registration content current status confirmation page displayed in the user terminal 100_{—}i. In a browser W330 in the figure, a list R331 of a current registration content of a certain user, an idea list R332 of additional devices that have been contributed by the user up to now and a list R333 of additional devices that are realized or manufactured by the user are shown.

In the list R331 of the current registration content of the certain user, a set of a name, a furigana, a user ID, a login password, a mail address, an address, a deposit bank account, a credit card and a user category is shown.

Further, a change button is displayed in the vicinity of the sections of the login password, the mail address, the address, the deposit bank account, the credit card and the user category.

When the change button is pushed, the user terminal 100_{—}i requests a resetting page of an item adjacent to the change button from the server apparatus 200. The server apparatus 200 transmits a source code of the resetting page to the user terminal 100_{—}i according to the request from the user terminal 100_{—}i. The user terminal 100_{—}i displays the resetting page based on the source code of the resetting page received from the server apparatus 200. Thus, the user can input new content for the item adjacent to the change button.

The user terminal 100_{—}i transmits update information indicating the received new content together with change item information indicating an item to be changed to the server apparatus 200. The server apparatus 200 updates the user registration information stored in Table T1 of the storage unit 210 of the apparatus using the change item information and the update information received from the user terminal 100_{—}i.

In the list R332 of the ideas of the additional devices that have been contributed by the user up to now, each set of an idea type, an idea ID, content of an idea, a current phase, an idea contribution date, the presence or absence of a mass production desire, a specification creation time limit, an acquired polling score, the presence or absence of idea employment, an idea royalty, novelty of the idea and the presence or absence of transfer proposal of a patentable right for the idea (right transfer proposal) is shown.

For example, as shown in the first line, when an idea ID is “1-0”, the idea type is “original”, the content of the idea is “camera capable of imaging when an object is stationary”, the current phase is “on sale”, the contribution date is “Apr. 5, 2011, 14:00:17”, the number of points is “10”, the presence or absence of the mass production desire is “present”, the specification creation time limit is “Apr. 30, 2011”, the acquired polling score is “256”, the presence or absence of employment is “commercialization”, the royalty is “50,000” yen, the novelty is “present”, and the right transfer proposal is “present”.

Further, total available points that are the sum of points are shown.

Here, in the idea ID, a number before a dash represents an original idea ID specific to an original idea. In the idea ID, a number after the dash represents an improved idea ID for identifying an improved idea, in which if the number is 0, it shows that the idea is the original idea.

For example, when the idea ID is “1-0”, the idea is an original idea of which the original idea ID is 1. When the idea ID is “2-1”, this shows that the idea is a first improved idea for an original idea of which the original idea ID is 2.

In the storage unit 210 of the server apparatus 200, information about the idea type, the idea ID, the content of the idea, the current phase, the idea contribution date, the presence or absence of the mass production desire, the specification creation time limit, the acquired polling score, the presence or absence of idea employment, the idea royalty, the novelty of the idea, and the right transfer proposal for the idea is associated with each other and stored.

In the list R333 of the additional devices that are realized or manufactured by the user, each set of an idea type, an idea ID, content of an idea, an appearance drawing, a part used in the additional device, a specification of the additional device, a price of the additional device, a manufacturer and a number of sales for the type is shown.

Here, as an example, it is shown that, when the idea ID is “1-0”, the idea type is “original”, the content of the idea is “camera capable of imaging when an object is stationary”, the appearance drawing is an appearance drawing of the additional device, the part is “lens A”, the specification is “digital camera of 1,000,000 pixels”, the price is “20,000” yen, the manufacturer is “ΔΔΔ (Co., Ltd.)”, and the number of sales for the type is “500,000”.

In the storage unit 210 of the server apparatus 200, information about the idea type, the idea ID, the content of the idea, the appearance drawing, the part used in the additional device, the specification of the additional device, the price of the additional device, the manufacturer and the number of sales for the type is associated with each other and stored.

The user terminal 100_{—}i designates the user ID for which to request a registration content current status confirmation page from the server apparatus 200. The server apparatus 200 reads a source code, from the storage unit 210, of the registration content current status confirmation page according to the request from the user terminal 100_{—}i. Further, the server apparatus 200 reads the registration information associated with the user ID, the idea information of the contributed additional device and the information about the additional device that is realized or manufactured up to now from the storage unit 210.

The server apparatus 200 inserts the registration content indicated by the read registration information, the idea indicated by the read idea information, and the content of the additional device indicated by the read information about the additional device that is realized or manufactured in predetermined positions of the source code of the read registration content current status confirmation page. The server apparatus 200 transmits the source code of the registration content current status confirmation page changed by the insertion to the user terminal 100_{—}i.

The user terminal 100_{—}i displays the registration content current status confirmation page based on the source code of the registration content current status confirmation page received from the server apparatus 200. Thus, the user can confirm the user's own commercialized idea and a royalty payment condition or the like for each user.

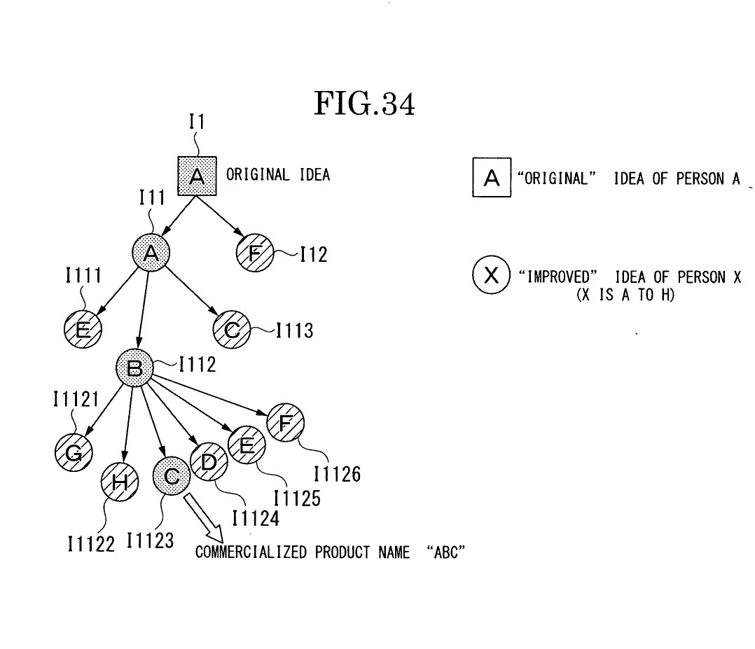

FIG. 34 is a diagram illustrating an image of a process in which an improved idea is derived from an original idea and finally leads to commercialization of product. In the figure, an original idea I1 of a person A is surrounded by a rectangle. Further, an improved idea I11 of the person A and an improved idea I12 of a person F derived from the original idea I1 of the person A are shown. Here, all the improved ideas are indicated by circled letters.

Further, an improved idea fill of a person E, an improved idea I112 of a person B and an improved idea I113 of a person C derived from the improved idea I11 of the person A are shown.

Further, an improved idea I1121 of a person G, an improved idea I1122 of a person H, an improved idea I1123 of the person C, an improved idea I1124 of a person D, an improved idea I1125 of the person E and an improved idea I1126 of the person F derived from the improved idea I112 of the person B are shown.

Further, finally, the improved idea I1125 of the person E is commercialized, and its product name is indicated as “ABC”.

The server apparatus 200 stores a point in association with an idea ID that provides (contributes) an idea. Further, when the idea leads to commercialization, the server apparatus 200 increases a number of points associated with an idea ID for identifying the idea by a predetermined number of points. Further, the server apparatus 200 may increase the number of points associated with the idea ID for identifying the idea according to the number of “improved ideas” derived from the idea.

Thus, the server apparatus 200 can assign a point to each idea that is contributed by a user in appropriate consideration of situations.

Here, the server apparatus 200 may determine the user category based on the total number of points for each user.

Further, when commercialization of an improved idea is determined, the server apparatus 200 may set a point ratio for a contributor of an original idea and a contributor of the improved idea as the shares of a royalty or a patentable right.

The server apparatus 200 may distribute the point ratio or the shares of the royalty or the patentable right as follows. With respect to the point ratio or the shares of the royalty or the patentable right, the server apparatus 200 may perform (1) an equal distribution, (2) a distribution based on the number of ideas, (3) a distribution advantageous for a user immediately before commercialization is determined, (4) a distribution advantageous for a user who provides an original idea, or (5) a distribution advantageous for a user who provides an improved idea having the largest number of followers.

Here, the distribution advantageous for the user immediately before the commercialization is determined is performed from a viewpoint that the degree of contribution of the user immediately before the commercialization is determined is large. Further, the distribution advantageous for the user who provides the original idea is performed from a viewpoint that the degree of contribution of the user who provides the original idea is large. Further, the distribution advantageous for the user who provides the improved idea having the largest number of followers is performed from a viewpoint that the degree of contribution of the user who provides an idea serving as the impetus for expansion of ideas is large.

In the case of the equal distribution, in the example in FIG. 34, the server apparatus 200 distributes the point ratio or the shares of the royalty or the patentable right to a person A, a person B and a person Cat ⅓.

In the case of the distribution based on the number of ideas, in the example in FIG. 34, the server apparatus 200 distributes the point ratio or the shares of the royalty or the patentable right at a ratio of A:B:C=2:1:1.

In the case of the distribution advantageous for the user immediately before the commercialization is determined, in the example in FIG. 34, the server apparatus 200 distributes the point ratio or the shares of the royalty or the patentable right at a ratio of A:B:C=1:1:10.

In the case of the distribution advantageous for the user who provides the original idea, in the example in FIG. 34, the server apparatus 200 distributes the point ratio or the shares of the royalty or the patentable right at a ratio of A:B:C=10:1:1.

In the case of the distribution advantageous for the user who provides the improved idea having the largest number of followers, in the example in FIG. 34, the server apparatus 200 distributes the point ratio or the shares of the royalty or the patentable right at a ratio of A:B:C=1:10:1.

Further, the server apparatus 200 may distribute the point ratio or the shares of the royalty or the patentable right based on a reference obtained by mixing the references of (1) to (5).

Further, a program for executing the respective processes of the server apparatus 200 of the present embodiment may be recorded on a computer-readable recording medium. In this case, a computer system may read the program recorded on the recording medium and may execute the program, to thereby perform the above-described various processes relating to the server apparatus 200.

Here, the “computer system” may include an OS and hardware such as a peripheral device. Further, when the WWW system is used, the “computer system” may include a homepage providing environment (or a display environment). Further, the “computer-readable recording medium” refers to a storage device such as a flexible disk, a magneto-optical disk, a ROM, a writable non-volatile memory such as a flash memory, a portable medium such as a CD-ROM, or a hard disk built in the computer system.

Further, the “computer-readable recording medium” includes a recording medium that holds a program for a predetermined time, such as a volatile memory (for example, a dynamic random access memory (DRAM)) inside the computer system that serves as a server or a client when the program is transmitted through a network such as the Internet or a communication channel such as a telephone line. Further, the program may be transmitted to a different computer system from the computer system that stores the program in the storage device or the like through a transmission medium or by a transmission wave in the transmission medium. Here, the “transmission medium” that transmits the program refers to a medium having a function of transmitting information, such as a network (communication network) such as the Internet or a communication channel (communication line) such as a telephone line. Further, the program may realize a part of the above-described functions. Further, the program may be a file capable of realizing the functions in cooperation with a program recorded in the computer system in advance, a so-called a differential file (differential program).

Hereinbefore, the embodiments of the invention are described in detail with reference to the accompanying drawings, but specific configurations are not limited to the embodiments and include a design or the like made in a range without departing from the scope of the invention.

1. A server apparatus comprising:
a communication unit that communicates with a user terminal and a manufacturer terminal;
an additional information communication unit that transmits, when the communication unit receives additional function information indicating a function to be added to a basic device from the user terminal, the additional function information to the manufacturer terminal through the communication unit;
a specification information communication unit that transmits, when the communication unit receives specification information indicating a specification of an additional device for realizing the function from the manufacturer terminal, the specification information to the user terminal through the communication unit; and
a specification determination unit that determines, when the communication unit receives, from the user terminal, selection information indicating one specification selected from among specifications indicated by the specification information transmitted to the user terminal, the one specification indicated by the selection information as the specification of the additional device.

2. The server apparatus according to claim 1,
wherein the additional information communication unit transmits, when the communication unit receives improved function information indicating an improved function associated with the function from the user terminal, the improved function information to the manufacturer terminal through the communication unit, and
wherein the specification information communication unit transmits, when the communication unit receives the specification information indicating the specification of the additional device for realizing the function or the improved function from the manufacturer terminal, the specification information to the user terminal through the communication unit.

3. The server apparatus according to claim 1,
wherein the specification information includes a part list for manufacturing the additional device, and
wherein the part list includes a basic module that is necessarily used when the additional device is manufactured and a selective module that is selectively used.

4. The server apparatus according to claim 3,
wherein the basic module includes a connecting member that connects the basic device and the additional device.

5. The server apparatus according to claim 3,
wherein the selective module includes at least one of a device that configures a photographing device, a vibration device, a microphone, a sensor and a display panel.

6. The server apparatus according to claim 1,
wherein the communication unit receives mass production desire presence/absence information indicating whether or not a mass production desire is present for the additional device that realizes the additional function from the user terminal,
the server apparatus further comprising:
a purchase demand research unit that researches a purchase demand of the additional device when the specification of the additional device is determined by the specification determination unit and when the received mass production desire presence/absence information indicates that the mass production desire is present.

7. The server apparatus according to claim 6, comprising:
a storage unit that stores purchase desire number information indicating the number of purchase desires,
wherein the purchase demand research unit includes
a questionnaire obtaining portion that obtains, if the communication unit receives access from a terminal device, questionnaire information indicating a questionnaire for inquiring about the presence or absence of the purchase desire of the additional device,
a communication control portion that causes the communication unit to transmit the obtained questionnaire information to the terminal device that displays the questionnaire information,
an updating portion that updates, whenever the communication unit receives answer information indicating an answer of the questionnaire from the terminal device, the purchase desire number information stored in the storage unit based on the answer information, and
a mass production determination portion that determines, when the number of the purchase desires exceeds a predetermined threshold value, mass production of the additional device.

8. The server apparatus according to claim 7,
wherein the specification information includes a price of the additional device, and
wherein the questionnaire inquires about the presence or absence of the purchase desire of the additional device by presenting the price of the additional device.

9. A specification determination method comprising:
transmitting, when additional function information indicating a function to be added to a basic device is received from a user terminal, the additional function information to a manufacturer terminal;
transmitting, when specification information indicating a specification of an additional device for realizing the function is received from the manufacturer terminal, the specification information to the user terminal; and
determining, when selection information indicating one specification selected from among specifications indicated by the specification information transmitted to the user terminal is received from the user terminal, the one specification indicated by the selection information as the specification of the additional device.

10. A specification determination program that causes a computer to execute a routine comprising:
an additional information communication step of transmitting, when a communication unit receives additional function information indicating a function to be added to a basic device from a user terminal, the additional function information to a manufacturer terminal through the communication unit;
a specification information communication step of transmitting, when the communication unit receives specification information indicating a specification of an additional device for realizing the function from the manufacturer terminal, the specification information to the user terminal through the communication unit; and
a specification determination step of determining, when the communication unit receives, from the user terminal, selection information indicating one specification selected from among specifications indicated by the specification information transmitted to the user terminal, the one specification indicated by the selection information as the specification of the additional device.
